(19) United States
(12) Patent Application Publication
(10) Pub. No.: US 2025/0077133 A1
(43) Pub. Date: Mar. 6, 2025

(54) NON-TRANSITORY COMPUTER-READABLE STORAGE MEDIUM STORING APPLICATION PROGRAM, INFORMATION PROCESSING APPARATUS, AND CONTROL METHOD

(71) Applicant: CANON KABUSHIKI KAISHA, Tokyo (JP)

(72) Inventor: YOICHIRO SHIBUYA, Saitama (JP)

(21) Appl. No.: 18/826,001

(22) Filed: Sep. 5, 2024

(30) Foreign Application Priority Data
Sep. 6, 2023 (JP) 2023-144453

(51) Int. Cl. G06F 3/12

(52) U.S. Cl. CPC G06F 3/1205; G06F 3/1228; G06F 3/1284; G06F 3/1285

(57) ABSTRACT

A non-transitory computer-readable storage medium stores an application program causing an information processing apparatus to perform a control method, the application program supporting a function of printing software. The control method includes obtaining capability information from a printer, storing print function information including information corresponding to the obtained capability information, and deleting at least one of a plurality of setting values indicated by the print function information based on restriction information about a print setting.

### FIELD OF THE DISCLOSURE

The present disclosure relates to a non-transitory computer-readable storage medium storing an application program, an information processing apparatus, and a control method.

### DESCRIPTION OF THE RELATED ART

Configurations for issuing print instructions to a printing apparatus connected to a host computer by using a printer driver installed on the host computer as control software for the printing apparatus have been known. An operating system (OS), or basic software, is installed on the host computer. The printer driver is configured in conformity with specifications defined by the OS, and called to operate by the OS. Vendors that provide printing apparatuses can provide means for instruction the printing apparatuses to print using the OS by providing printer drivers that comply with the OS specifications.

In recent years, Windows (registered trademark) has provided a standard class driver (hereinafter, also referred to as a “generic printer driver”) commonly usable with printing apparatuses provided by a plurality of vendors. Such a generic printer driver is bundled in the OS package, and can be easily used by connecting a given printing apparatus to the host computer. This is convenient since model-specific printer drivers suited to the printing apparatuses do not need to be separately installed. Moreover, the generic printer driver is configured so that print functions can be specified depending on PrintCapabilities generated based on information obtained from the connected printing apparatus. The user who uses the generic printer driver can thus specify print functions compatible with the capabilities of connected printing apparatuses despite using a single standard driver.

The generic printer driver can be associated with applications for extending functions (hereinafter, also referred to as “extension applications”). The extension applications can be provided by the vendors that provide printing apparatuses. The extension applications can provide functions (extended functions) that are unable to be implemented with the generic printer driver alone by editing Print Device Capabilities (PDCs) generated by the generic printer driver. Japanese Patent Application Laid-Open No. 2019-74906 discusses a technique for extending functions such as a stamp function using the extension application.

With the generic printer driver, the setting items and setting values that can be set by print settings, as well as default values to be displayed, are determined based on information obtained from the printing apparatus. Such values are typically determined by information registered in the printing apparatus in advance. However, companies and organizations may want to customize the usable setting items, setting values, and values to be displayed by default.

### SUMMARY

According to an aspect of the present disclosure, a non-transitory computer-readable storage medium stores an application program causing an information processing apparatus to perform a control method, the application program supporting a function of printing software. The control method includes obtaining capability information from a printer, storing print function information including information corresponding to the obtained capability information, and deleting at least one of a plurality of setting values indicated by the print function information based on restriction information about a print setting.

Further features of the present disclosure will become apparent from the following description of exemplary embodiments with reference to the attached drawings.

### BRIEF DESCRIPTION OF THE DRAWINGS

FIGS. 1A and 1B are block diagrams illustrating an example of a hardware configuration of a printing system according to one or more aspects of the present disclosure.

FIGS. 2A and 2B are diagrams illustrating examples of a configuration of the printing system according to one or more aspects of the present disclosure.

FIGS. 3A and 3B are diagrams illustrating examples of a screen displayed by a print setting screen extension unit.

FIGS. 4A and 4B are charts illustrating examples of print options and default print options for print functions, and custom setting information.

FIG. 5A is a sequence diagram illustrating an example of a procedure where an administrator distributes a customized extension application for customization. FIG. 5B is a sequence diagram illustrating an example of a procedure where the administrator distributes custom setting information for customization. FIG. 5C is a sequence diagram illustrating an example of a procedure where the custom setting information is obtained from a server for customization.

FIG. 6 is a flowchart illustrating an example of processing for reflecting custom setting information according to one or more aspects of the present disclosure.

FIGS. 7A and 7B are a diagram illustrating an example of a Print Device Capabilities (PDC) file edited by the extension application using only capability information about a printing apparatus.

FIGS. 8A and 8B are a diagram illustrating an example of the PDC file edited by the extension application using the capability information about the printing apparatus and the custom setting information.

FIGS. 9A to 9C are diagrams illustrating examples of a screen that the print setting screen extension unit displays based on the PDC file.

FIG. 10 is a flowchart illustrating an example of processing for reflecting custom setting information according to one or more aspects of the present disclosure in.

FIG. 11 is a diagram illustrating an example of a configuration of a printing system according to one or more aspects of the present disclosure.

FIG. 12 is a sequence diagram where an administrator creates and distributes custom setting information according to one or more aspects of the present disclosure.

FIGS. 13A and 13B are diagrams illustrating an example of an apparatus management interface of a printing apparatus on a cloud print service.

FIG. 14 is a flowchart illustrating processing for reflecting the custom setting information according to one or more aspects of the present disclosure.

FIG. 15 is a flowchart illustrating a modification of the processing for reflecting the custom setting information according to one or more aspects of the present disclosure.

FIG. 16 is a diagram illustrating an example of registry keys for associating a modified extension application with a print queue by priority.

FIG. 17 is a diagram illustrating an example of registry keys for mandating the use of the extension application.

### DESCRIPTION OF THE EMBODIMENTS

Exemplary embodiments of the present disclosure will be described in detail below with reference to the attached drawings. The following exemplary embodiments are not intended to limit the present disclosure set forth in the claims, and all combinations of features described in the exemplary embodiments are not necessarily essential to the solving means of the present disclosure.

Similar components will be denoted by the same reference numerals, and a description thereof will be omitted.

### Hardware Configuration of Printing System

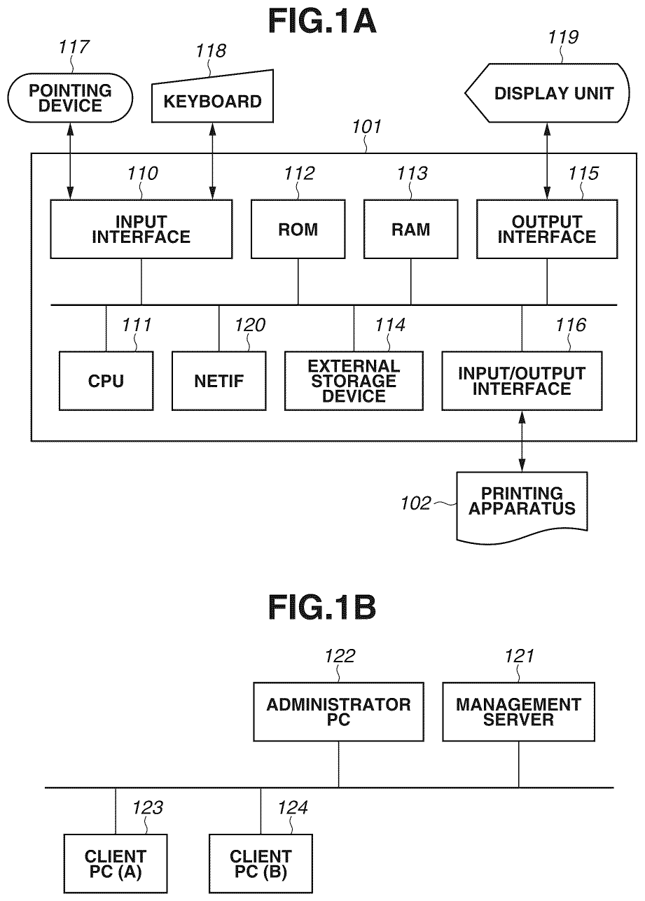

A first exemplary embodiment of the present disclosure will be described below. FIG. 1A is a block diagram illustrating a hardware configuration of a printing system. In the diagram, a host computer 101 is an example of an information processing apparatus, and includes an input interface 110, a central processing unit (CPU) 111, a read-only memory (ROM) 111, a random access memory (RAM) 113, an external storage device 114, an output interface 115, and an input/output interface 116. Input devices such as a keyboard 118 and a pointing device 117 are connected to the input interface 110. A display device such as a display unit 119 is connected to the output interface 115. A network interface (NETIF) 120 controls data transfer with an external apparatus via a network.

The ROM 112 stores an initialization program. The external storage device 114 stores an application program group, an operating system (OS), print data generation software, and various other types of data. The RAM 113 is used as a work memory in executing various programs stored in the external storage device 114, so that the various programs can be run on the host computer 101.

In the present exemplary embodiment, the CPU 111 performs processing based on the procedures of programs stored in the ROM 112, so that the functions of the host computer 101 to be described below and processing related to a flowchart to be described below are executed. The printing apparatus 102 that is a device is connected to the host computer 101 via the input/output interface 116. While the host computer 101 and the printing apparatus 102 are separately configured, the two may be configured as a single information processing apparatus. The printing apparatus 102 will be described using an inkjet printer that prints by discharging ink to a sheet of paper as an example. However, the printing may be performed with other methods (e.g., electrophotographic printing). The host computer 101 may be a desktop personal computer, a smartphone, or a laptop personal computer.

FIG. 1B will be described below.

### Software-Centered Configuration of Printing System

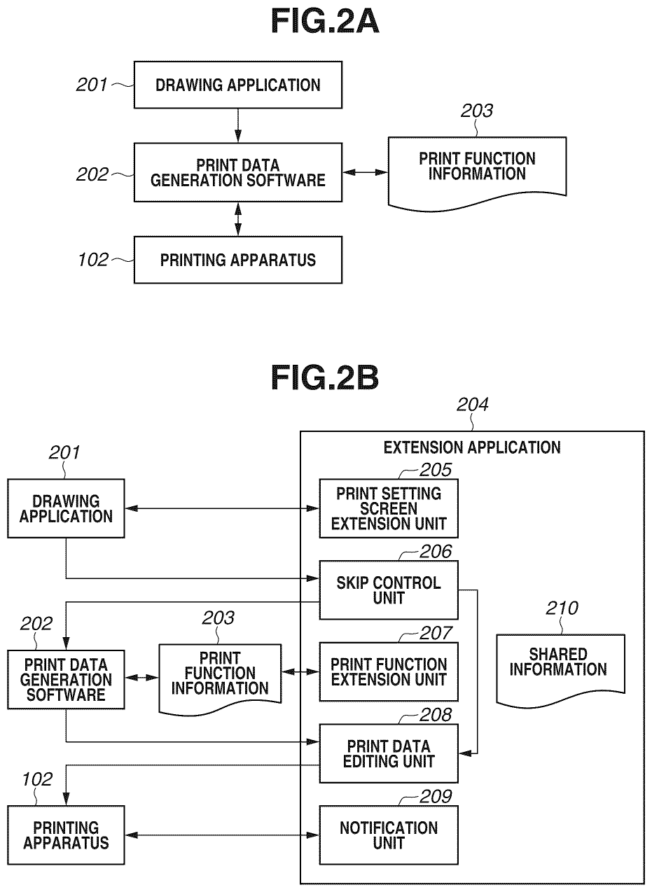

FIGS. 2A and 2B are diagrams schematically illustrating a software-centered configuration of the printing system. The following description will be provided based on the premise that the printing system uses the host computer 101 equipped with Microsoft (registered trademark) Windows (registered trademark) 11 as the OS. FIG. 2A is a diagram illustrating a general configuration in a case where an extension application 204 is not associated with print data generation software 202 or the printing apparatus 102.

A drawing application 201 is software for generating content (drawing data) to be printed. Examples of the drawing application 201 include word processing applications and spreadsheet applications. In response to receiving a print request from the user, the drawing application 201 issues a print instruction to the OS. The print instruction includes print setting information for instructing operation of the print data generation software 202 and the printing apparatus 102. The print setting information is also referred to as a Print Ticket (PT).

To output the print setting information, the drawing application 201 can display a print setting screen provided by one of the print data generation software 202, the OS, and the drawing application 201. The print setting screen includes setting items (hereinafter, also referred to as “control items”) representing settable print functions and control items indicating their setting values based on capability information (information settable as print settings) obtained from the print data generation software 202. The capability information is also referred to as PrintCapabilities (Hereinafter, referred to as PCs). The print data generation software 202 determines PCs based on print function information 203. The print function information 203 is print function-indicating data that describes all settable print functions and their setting values, as well as exclusive relationships between setting values. The print function information 203 is also referred to as Print Device Capabilities (PDCs). PDCs 203 are included in a configuration file of the print data generation software 202. PDCs 203 are dynamically generated by the print data generation software 202. Specifically, the print data generation software 202 or the OS can be configured to obtain attribute data on the printing apparatus 102 from the printing apparatus 102, and generate PDCs 203 based on attribute information in the obtained attribute data. The generated PDCs 203 are editable. The attribute data on the printing apparatus 102 obtained from the printing apparatus 102 refers to a response obtained by issuing an Internet Printing Protocol (IPP) Get-Printer-Attributes operation to the printing apparatus 102. The response includes attribute information (setting items) indicating functions specifiable on the printing apparatus 102 (capabilities of the printing apparatus 102) and setting values related to the attribute information. The response is stored in the RAM 113.

With such a configuration, the print data generation software 202 can enable, depending on printing apparatuses 102 connected, the user to specify print functions that are supported by the respective printing apparatuses 102. In other words, even if printing apparatuses 102 having different functions or developed by different vendors are connected, the print data generation software 202 can enable the user to specify usable print functions based on the printing apparatuses 102 connected. Here, a configuration where IPP Class Driver or Universal Print (UP) Class Driver included in Windows (registered trademark) 11 is used as the print data generation software 202 will be described. IPP Class Driver and UP Class Driver are generic printer drivers for performing print processing based on standard print protocol specifications called IPP, and bundled in the OS package. IPP Class Driver and UP Class Driver are not printer drivers specific to the model of the printing apparatus 102, but standard class drivers that are commonly usable with a plurality of printing apparatuses 102. IPP Class Driver is a standard driver for performing local printing, and the UP Class Driver cloud printing, in conformity with the foregoing specifications. If cloud printing is performed using UP Class Driver, the print data is not directly transmitted to the printing apparatus 102, but transmitted via a cloud print service and printed by the printing apparatus 102. IPP Class Driver and UP Class Driver obtain the capability information about the connected printing apparatus 102 and generate the print function information 203 based on the capability information so that the user can specify the print functions supported by the connected printing apparatus 102.

The OS generates intermediate data (also referred to as input data) based on the print instruction output from the drawing application 201, and passes the intermediate data to the print data generation software 202. The data that the drawing application 201 outputs for printing is data of Graphic Device Interface (GDI) format or Extensible Markup Language (XML) Paper Specification (XPS) format. If the drawing application 201 outputs data of GDI format, the OS converts the data of GDI format output by the drawing application 201 into data of XPS format. The OS then passes the converted data of XPS format to the print data generation software 202 as the intermediate data. If the drawing application 201 outputs data of XPS format, the OS passes the data of XPS format to the print data generation software 202 as the intermediate data. The intermediate data includes drawing data that is information about the image to be drawn on a sheet of paper, and print setting information set by the user.

The print data generation software 202 coverts the obtained intermediate data into print data that is interpretable by the printing apparatus 102, and transmits the print data to the printing apparatus 102. The print data includes the drawing data that is the information about an image to be formed on a sheet, and print setting attribute information (attribute information for specifying print settings) generated based on the print setting information set by the user. The print setting attribute information includes attribute information indicating the settable functions of the printing apparatus 102 (capabilities of the printing apparatus 102), and setting values related to the attribute information.

The printing apparatus 102 prints on the sheet based on the print data transmitted from the print data generation software 202. Here, the printing apparatus 102 forms the drawing data included in the print data on the sheet through operation based on the print setting attribute information included in the print data. The print setting attribute information includes attribute information for specifying print quality (such as image quality priority and speed priority) and two-sided printing, and its setting values. For example, if the print setting attribute information includes attribute information specifying two-sided printing, the printing apparatus 102 performs two-sided printing.

FIG. 2B is a diagram illustrating a configuration in a case where the extension application 204 is associated with the print data generation software 202 and the printing apparatus 102. The extension application 204 functions as a print setting application for extending the functions of the print data generation software 202. Components and processing not mentioned in particular below are similar to those of FIG. 2A.

The extension application 204 is software for extending the functions of the print data generation software 202, and not included in (not bundled with) the OS beforehand. The user therefore is to operate the host computer 101 to download the extension application 204 from a server via the Internet and installs the extension application 204. Alternatively, the extension application 204 may be automatically installed based on the connection of the printing apparatus 102 to the host computer 101. Specifically, the OS obtains device identification information from the printing apparatus 102 when the printing apparatus 102 is connected to the host computer 101.

The OS may download the extension application 204 corresponding to the obtained device identification information from the server via the Internet, and install the extension application 204. In other words, the print data generation software 202 and the extension application 204 are stored in the host computer 101 as separate files.

The print data generation software 202 and the extension application 204 may be updated to new versions, whereas the update processing is performed at respective different timings. In other words, the timing when the host computer 101 obtains the print data generation software 202 and the timing when the host computer 101 obtains the extension application 204 are different. The trigger for the host computer 101 to obtain the print data generation software 202 and the trigger to obtain the extension application 204 are also different. When the extension application 204 is installed, the OS associates the extension application 204 with the print data generation software 202 and the printing apparatus 102.

The extension application 204 described in the present exemplary embodiment includes a print setting screen extension unit 205, a skip control unit 206, a print function extension unit 207, a print data editing unit 208, and a notification unit 209. The extension application 204 further includes shared information 210 that is commonly accessible from the units. The shared information 210 is stored in a file stored in the external storage device 114, or in the RAM 113. The extension application 204 can freely write and read information to/from the shared information 210 using an application programming interface (API) provided by the OS. The shared information 210 is allocated as an area where application-specific information can be stored, and information other than the attribute data on the printing apparatus 102 can also be stored. The shared information 210 is different from PDCs 203 that are generated by the print data generation software 202 or the OS to specify the print functions usable by the connected printing apparatus 102.

The operation of the extension application 204 may be terminate each time one of the units finishes processing. In such a case, the OS activates the extension application 204 each time a request to use one of the units is received. Other configurations are applicable. For example, when the print setting screen extension unit 205 finishes processing, the OS may terminate the operation of the extension application 204. By contrast, when the skip control unit 206 finishes processing, the OS may keep the extension application 204 running.

The extension application 204 may cancel ongoing processing of each unit. If processing is cancelled, the job being processed in the print queue is deleted by the OS.

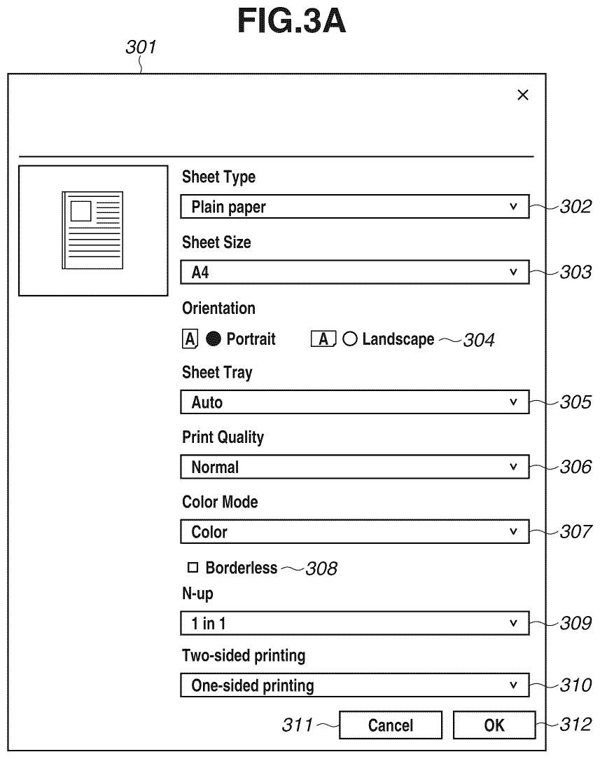

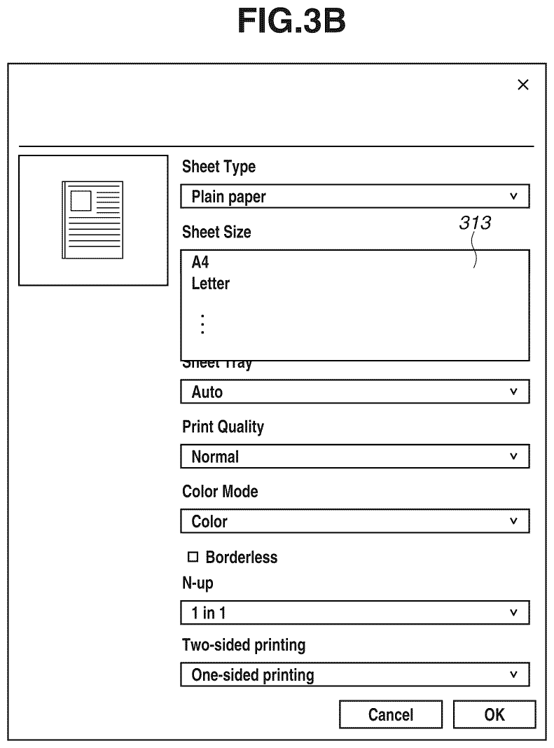

Receiving a print request from the user, the drawing application 201 issues a print instruction to the OS. In the present configuration, as with the configuration of FIG. 2A, the drawing application 201 can display a print setting screen. In the present configuration, the drawing application 201 displays a print setting screen provided by the extension application 204. Specifically, a print setting screen provided by the print setting screen extension unit 205 included in the extension application 204 is displayed. Note that whether to display the print setting screen provided by the print setting screen extension unit 205 depends on the user's operation. For example, if the drawing application 201 is a word processing application or a spreadsheet application and the user presses a property setting button on the print setting screen provided by the application, the print setting screen provided by the print setting screen extension unit 205 is displayed. Details of the print setting screen extension unit 205 will be described below with reference to FIGS. 3A and 3B.

When the drawing application 201 accepts a print request from the user and issues a print instruction to the OS, the OS activates the skip control unit 206. The skip control unit 206 controls a skip of the processing of the print data generation software 202. The processing of the print data generation software 202 refers to the processing for generating drawing data based on intermediate data. The skip control unit 206 is unable to obtain the intermediate data or the print setting information. After the skip control processing performed by the skip control unit 206, the OS generates intermediate data based on the print instruction output from the drawing application 201, and passes the intermediate data to the print data generation software 202. If the skip control unit 206 does not perform the skip control, the print data generation software 202 processes the intermediate data into print data interpretable by the printing apparatus 102, and passes the print data to the print data editing unit 208. On the other hand, if the print data generation software 202 is skipped, the intermediate data is passed to the print data editing unit 208 without being processed by the print data generation software 202. This enables the print data editing unit 208 to process the intermediate data. An example of the case where the print data generation software 202 is desirably skipped is when scaling processing is intended to be performed by the print data editing unit 208. The intermediate data can retain data in a vector format and does not much degrade during scaling. In a mode where the print data generation software 202 outputs an image of raster format, it is typically desirable to skip the processing of the print data generation software 202 and process the intermediate data with the print data editing unit 208.

The print data editing unit 208 edits the intermediate data passed from the print data generation software 202 or the print data processed by the print data generation software 202. Assume N-up printing as an example of the editing. The print data editing unit 208 changes the layout of the intermediate data or the print data based on the print setting information about the N-up printing, received from the OS. The N-up printing refers to a function of laying out as many pages of image data as specified by the user on one side of a sheet and printing the resulting print data. The print data editing unit 208 can display a user interface (UI) screen on the display unit 119, and can display the layout result of the intermediate data or the print data as a preview screen. The print data editing unit 208 does not transmit the print data to the printing apparatus 102 with the UI screen open, and performs processing of transmitting the print data when the UI screen is closed.

After the print data editing unit 208 edits the print data, the print data is passed to the printing apparatus 102 via the OS. The printing apparatus 102 prints on the sheet based on the received print data. If the print data generation software 202 is skipped by the skip control unit 206, the print data editing unit 208 may convert the received intermediate data into print data interpretable by the printing apparatus 102. To convert the intermediate data into the print data, the print data editing unit 208 may use functions provided by the OS.

The extension application 204 includes the print function extension unit 207. The print function extension unit 207 can edit PDCs 203 generated by the print data generation software 202 or the OS. The print function extension unit 207 can thereby add functions provided by the extension application 204. The print function extension unit 207 can also add functions that are supported by the printing apparatus 102 but not by the print data generation software 202, and add exclusive relationships between setting values of print functions. The OS activates the print function extension unit 207 when the extension application 204 is associated with the printing apparatus 102 and the print data generation software 202 for the first time. The OS may also activate the print function extension unit 207 at other timing, such as upon startup of the OS. In a case where an optional device (such as a finisher) is added to the printing apparatus 102 afterward and printing-related functions are extended, the print function extension unit 207 can thus detect the extended functions and add the extended functions to PDCs 203.

The extension application 204 includes the notification unit 209. The notification unit 209 can display a notification to the user in response to the occurrence of an error on the printing apparatus 102. For example, if a paper-out error occurs in the printing apparatus 102, the print data generation software 202 detects the error and displays a message on the display unit 119 using a notification function called toast notification, which is a function of the OS. If the user presses the toast notification, the notification unit 209 of the extension application 204 is called by the OS and a UI screen of the notification unit 209 is displayed. The UI screen of the notification unit 209 can display, for example, a detailed message about the paper-out error and instructions on how to load sheets.

Once the extension application 204 transmits the print data to the printing apparatus 102, the extension application 204 is unable to provide a screen display, such as guides in association with the print data while each unit is processing.

The extension application 204 for implementing the present exemplary embodiment is not limited to the configuration including all the foregoing functions (units). The extension application 204 may include only some of the functions, and/or include other functions as well. The extension application 204 may be simply called printing software. As described above, the extension application 204 includes at least one of the functions represented by the units 205 to 209.

### Examples of Screen Displayed by Print Setting Screen Extension Unit

Next, the print setting screen displayed by the print setting screen extension unit 205 will be described with reference to FIGS. 3A and 3B.

PCs are generated based on PDCs 203 edited by the print function extension unit 207. FIG. 3A illustrates a print setting screen 301, which is an example of the screen displayed by the print setting screen extension unit 205 based on the generated PCs. The print setting screen extension unit 205 is called by the OS when the user instructs the drawing application 201 to display a print setting screen. The print setting screen extension unit 205 displays a screen where the user can specify the setting values of the print functions specifiable by the print data generation software 202, based on PCs that can be obtained from the OS.

A control 302 is a control item with which the type of sheet to be used for printing is settable. Items such as plain paper and photo paper can be set, for example. A control 303 is a control item capable of setting the size of sheet to be used for printing. Setting values such as A4 and Letter can be set, for example. A list 313 illustrated in FIG. 3B represents the state of display when the control 303 is expanded. The user can select a sheet size from the expanded list.

A control 304 is a control item with which printing orientation is settable. Specifically, portrait and landscape are settable. A control 305 is a control item with which the sheet feed port of the printing apparatus 102 is settable. Setting values such as a main tray and a rear tray can be set, for example. A control 306 is a control item with which high, normal, and draft are settable to print quality. A control 307 is a control item with which color mode is settable. A control 308 is a control item with which whether to print a borderless image in printing an image on a print sheet is selectable. A control 309 is a control item for selecting the N-up method in printing images on a print sheet. A control 310 is a control item capable with which two-sided printing is switchable between on and off. A control 311 is a cancel button, by which the screen is closed with the settings not being applied.

A control 312 is an OK button, by which the screen is closed with the settings applied.

### Changes in Print Settings by Administrator

The print data generation software 202 or the OS is configured to obtain the attribute data on the printing apparatus 102 from the printing apparatus 102 and generate PDCs 203 based on the attribute information in the obtained attribute data. Setting values related to the attribute information indicating the normally selectable functions of the printing apparatus 102 and setting values given highest priority are thus constituted by the attribute data obtained from the printing apparatus 102. The attribute information indicating the normally selectable functions of the printing apparatus 102 will hereinafter be referred to as print functions. The setting values related to the print functions will be referred to as print options. The setting values displayed as initial values for the respective print functions will be referred to default print options.

However, companies or organizations want to change the default print options or make some of the print options not selectable due to specific circumstances, such as reducing printing costs, saving resources, and preventing printing failures.

The present exemplary embodiment describes processing for changing the default print options and making some of the print options not selectable by using the extension application 204 on each host computer 101 in a company or an organization.

In the following description, the print function extension unit 207 or the print setting screen extension unit 205 of the extension application 204 may be described as the main agent of each process. In practice, the functions are implemented by the CPU 111 executing corresponding programs.

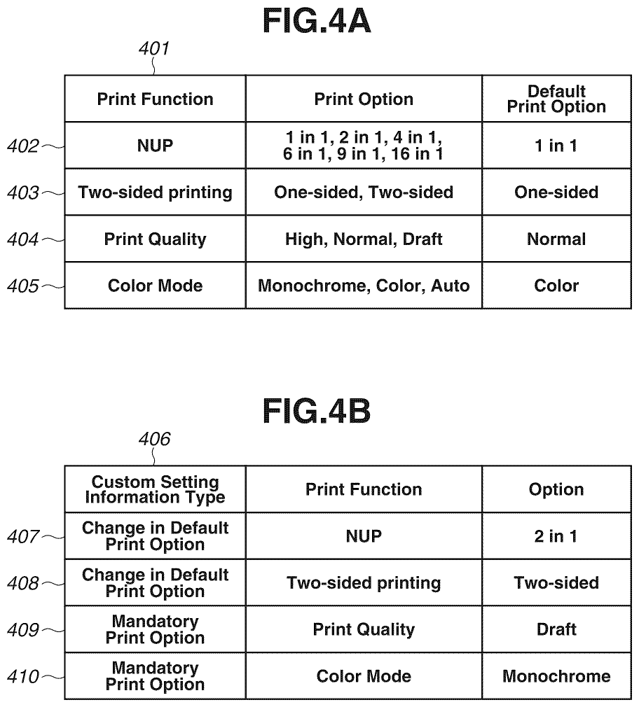

An example of the foregoing print functions, print options, and default print options will initially be described with reference to FIG. 4A. FIG. 4A is a print function list 401 schematically illustrating the print functions, print options, and default print options based on the capability information obtained from the printing apparatus 102. Each row of the print function list 401 represents a combination of a print function, print options, and a default print option. A row 402 indicates that five print options 1 in 1, 2 in 1, 4 in 1, 6 in 1, 9 in 1, and 16 in 1 are selectable for “print function: N-up”, and the default print option is 1 in 1. In other words, a setting to lay out one page of image data on one side of a sheet is made to be a default.

A row 403 indicates that one-sided printing and two-sided printing are selectable as the print options for “print function: two-sided printing”, and the default print option is one-sided printing. Similarly, a row 404 indicates that three types of print options high, normal, and draft are selectable for “print function: print quality”, and the default print option is normal. A row 405 indicates that three types of print options, namely monochrome, color, and auto, can be selected for “print function: color mode”, and the default print option is color. In the present exemplary embodiment, these four types of print functions and their print options and default print options are described as an example. However, combinations of other print functions, print options, and default print options may be used.

FIG. 4B is a custom setting information list 406 that describes restriction information for disabling changes in default print options and selection of some of the print options due to the company or organization's specific circumstances, unlike the capability information obtained from the printing apparatus 102. Each row of the custom setting information list 406 indicates a custom setting information type, a print function, and an option. Specifically, a row 407 means that a change in a default print option is specified as the custom setting information type, and the default print option for “print function: N-up” is changed to 2 in 1. In other words, a setting to lay out two pages of image data on one side of a sheet is specified as a default. In the present exemplary embodiment, a change in a default print option refers to changing the option of each function that the print data generation software 202 or the extension application 204 displays by priority in displaying a print setting screen based on PCs generated from PDCs 203. The initial value for the NUP (N-up) function when the drawing application 201 or the extension application 204 displays a print setting screen can thereby be set to 2 in 1.

A row 408 means that a change in a default print option is specified as the custom setting information type, and the default print option for “print function: two-sided printing” is changed to two-sided. The initial value for the two-sided printing function when the drawing application 201 or the extension application 204 displays a print setting screen can thereby be set to two-sided.

A row 409 means that the custom setting information type is a mandatory print option, and the print option draft is mandated for “print function: print quality”. The print quality “draft” is a setting value to lower the image quality for increased printing speed. In the present exemplary embodiment, a mandatory print option means that the option for the print function is fixed to only one type when the print data generation software 202 or the extension application 204 displays a print setting screen based on PCs generated from PDCs 203. Similarly, a row 410 means that the print option monochrome is mandated for “print function: color mode”.

The extension application 204 customizes the print functions based on the company or organization's requests using the custom setting information list 406. The processing of the extension application 204 will be described below.

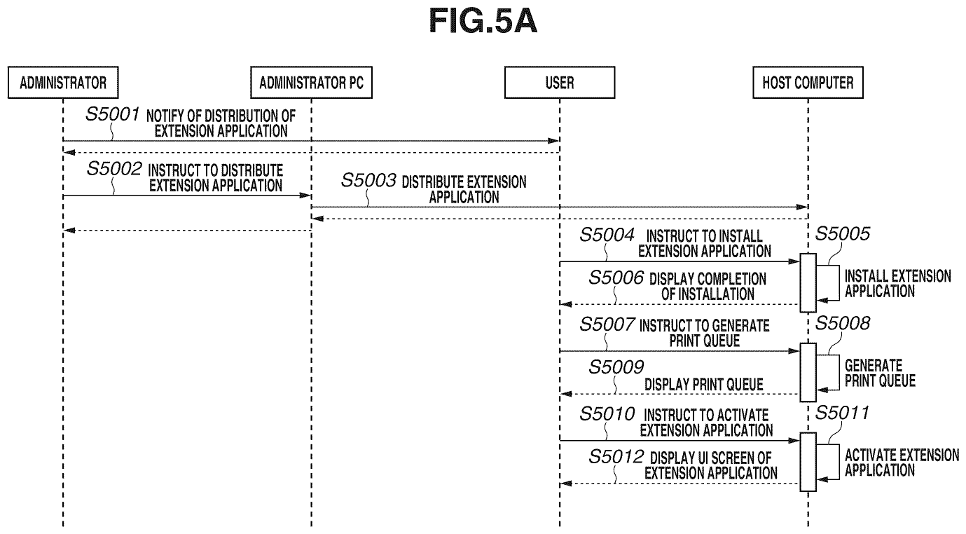

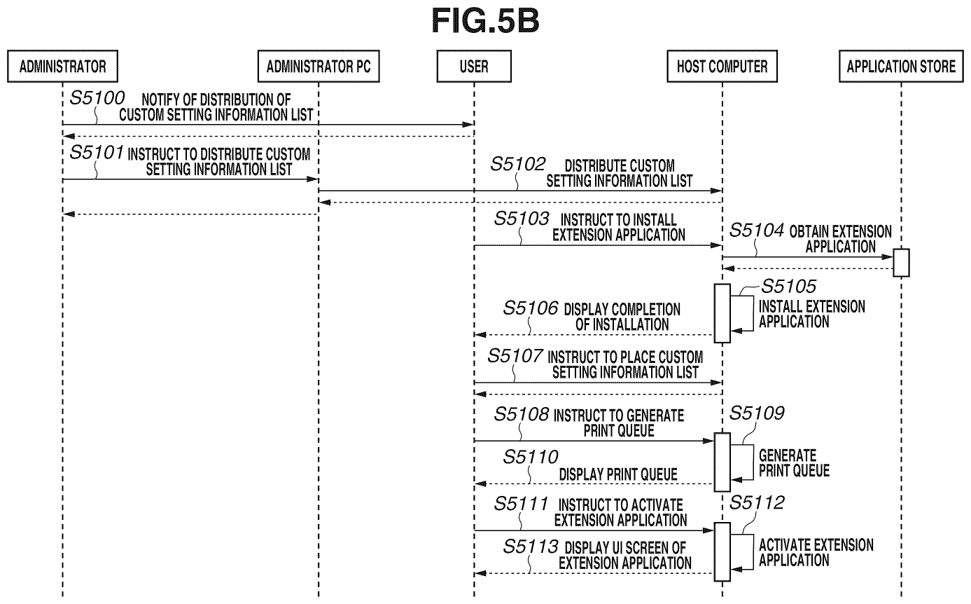

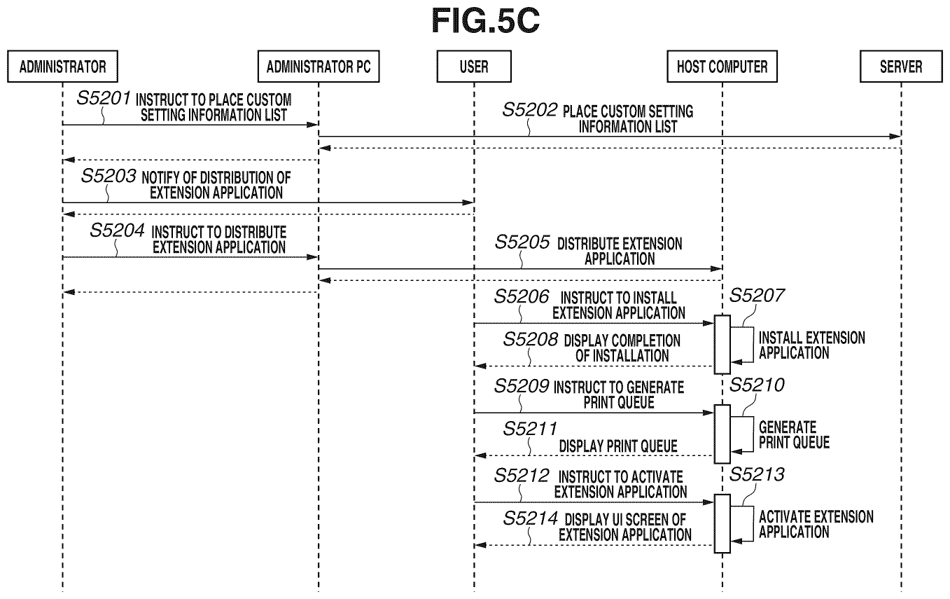

Next, a processing procedure where a company or organization's administrator creates the custom setting information list 406, distributes the custom setting information list 406 to users in the company or organization, and a user activates the extension application 204 will be described with reference to FIGS. 5A to 5C. There can be a plurality of methods for the administrator to distribute the custom setting information list 406 to the users. In the present exemplary embodiment, the methods will be separately described with reference to FIGS. 5A to 5C.

FIG. 5A is a diagram illustrating a sequence in a case where the custom setting information list 406 is included in the extension application 204 itself. In the case of FIG. 5A, to accommodate the custom setting information list 406 to be set for the target company or organization, the extension application 204 is desirably dedicatedly modified and provided for the company or organization's administrator.

In step S5001, the company or organization's administrator having received the extension application 204 that has been dedicatedly configured for the company or organization notifies the users that the extension application 204 is to be distributed. Specifically, company or organization's administrator can inform the users that the extension application 204 is to be distributed through posting on the company or organization's internal website, verbal communication, e-mail, or other communication tools.

In distributing the dedicatedly configured extension application 204, setup information for associating the extension application 204 with the print data generation software 202 is distributed along with the extension application 204. In the present exemplary embodiment, the setup information refers to a file called an extended INF file with an extension.inf. However, other file formats may be used.

In step S5002, the administrator instructs an administrator personal computer (PC) to distribute the extension application 204. In step S5003, the administrator PC distributes the extension application 204 to the host computers 101 in the company or organization. As a method for distributing the extension application 204 from the administrator PC, the administrator PC may distribute the extension application 204 to the users' host computers 101 by e-mail. Alternatively, the administrator may access a shared server in the company or organization from the administrator PC and place the extension application 204, and user PCs (host computers) may obtain the extension application 204 from the server. Similarly, the extension application 204 may be distributed using a cloud storage service shared in the company or organization. The administrator may distribute the extension application 204 to the host computers 101 managed in the company or organization via the administrator PC using a client PC management tool. A configuration of the printing system using the client PC management tool will now be described with reference to FIG. 1B.

FIG. 1B is a schematic diagram illustrating the printing system in a company or organization where the client PC management tool is introduced. In this printing system, a management server 121 for performing client management, an administrator PC 122, a client PC (A) 123, and a client PC (B) 124 are communicably connected via a network. The client PC (A) 123 and the client PC (B) 124 are computers having a hardware configuration similar to that of the host computer 101. The administrator using the administrator PC 122 can manage the configuration of the client PC (A) 123 and the client PC (B) 124, and manage and distribute software. In the present exemplary embodiment, client PC management tools are installed on the client PC (A) 123 and the client PC (B) 124, and the extension application 204 and a file describing the custom setting information can be distributed from the administrator.

Return to the description of FIG. 5A. As described above, the administrator distributes the extension application 204 including the custom setting information to the users. The processing proceeds to step S5004.

In step S5004, a user in the company or organization instructs their own host computer 101 to install the extension application 204. In step S5005, the host computer 101 installs the extension application 204. Here, the host computer 101 simultaneously installs the extended INF file that is the setup information about the extension application 204. After the completion of the installation, in step S5006, the host computer 101 displays the completion of the installation on the display unit 119 for user notification. In step S5007, the user in the company or organization instructs the host computer 101 to generate a print queue. In step S5008, in response to receiving the user instruction, the host computer 101 generates a print queue. Here, the host computer 101 associates the extension application 2004 installed in step S5005 with the print queue. In step S5009, the host computer 101 displays the generated print queue to the user via the display unit 119. In step S5010, the user in the company or organization instructs the host computer 101 to activate the installed extension application 204. In step S5011, the host computer 101 activates the extension application 204. In step S5012, the host computer 101 displays a UI screen of the extension application 204 on the display unit 119. Details of the processing performed by the extension application 204 after the extension application 204 is activated by the user in step S5010 until the extension application 204 displays the UI screen on the display unit 119 in step S5012 will be described below.

FIG. 5B is a diagram illustrating an example of the sequence in a case where the custom setting information list 406 is not included in the extension application 204 but separately placed in an area accessible by the extension application 204.

In FIG. 5B, since the extension application 204 itself does not include the information, the custom setting information can be relatively easily modified as compared with FIG. 5A. The extension application 204 does not need to be one modified for the company or organization in advance, either.

In step S5100, the administrator initially notifies the users that the custom setting information list 406 is to be distributed. Specifically, as in step S5001, the administrator can inform the users that the custom setting information list 406 is to be distributed through posting on the company or organization's internal website, verbal communication, e-mail, or other communication tools.

The administrator creates the custom setting information list 406. The content of the custom setting information list 406 is the list of FIG. 4B described above, and may be stored in any format. Specifically, any format such as ini, XML, JavaScript Object Notation (JSON), YAML Ain't Markup Language (YAML), Tom's Obvious Minimal Language (TOML), and Property List (PLIST) can be used. The registry of the host computer 101 may be edited.

In step S5101, the administrator instructs the administrator PC to distribute the custom setting information list 406. In step S5102, the administrator PC distributes the custom setting information list 406 to the host computers 101 in the company or organization. As a method for distributing the custom setting information list 406, the administrator PC may distribute the custom setting information list 406 to the users' host computers 101 by e-mail as described above. Alternatively, the administrator may access a shared server in the company or organization from the administrator PC and place the custom setting information list 406, and the users may obtain the custom setting information list 406 from the server. Similarly, the custom setting information list 406 may be distributed using a cloud storage service shared in the company or organization. The administrator may distribute the custom setting information list 406 to the host computers 101 managed in the company or organization via the administrator PC using an endpoint management tool.

In step S5103, a user in the company or organization instructs the host computer 101 to install the extension application 204. In step S5104, the host computer 101 requests an application download service (hereinafter, referred to as an application store) provided by Microsoft to obtain the extension application 204, and downloads the extension application 204. While in the present exemplary embodiment the extension application 204 is obtained from the service provided by the Microsoft, the extension application 204 may be obtained from other application download services or other websites. In the present exemplary embodiment, the user is assumed to positively obtain the extension application 204 from the application store. However, the extension application 204 may be automatically downloaded from the application store and installed on the host computer 101 at timing when the host computer 101 is connected to the printing apparatus 102. The automatic download and installation of the extension application 204 onto the host computer 101 is more convenient since the extension application 204 can be obtained without the user accessing the application store.

In step S5105, the host computer 101 installs the extension application 204 obtained from the application store. In step S5106, the host computer 101 notifies the user that the installation of the extension application 204 is completed.

In step S5107, the user places the distributed custom setting information list 406 in a predetermined information storage area of the host computer 101. The predetermined information storage area is generated by the OS when the extension application 204 is installed on the host computer 101, and can be accessed by the extension application 204. While in the present exemplary embodiment the user places the custom setting information list 406 distributed in advance into the predetermined information storage area, the custom setting information list 406 may be placed by the administrator instead of the user. Specifically, the administrator can access the foregoing endpoint management tool from the administrator PC and distribute the custom setting information list 406 to predetermined storage areas in the host computers 101 managed. The distribution of the custom setting information list 406 by the administrator can be said to be desirable because the application of the custom setting information is not committed to each user's operation.

In step S5108, the user in the company or organization instructs the host computer 101 to generate a print queue. In step S5109, in response to receiving the user instruction, the host computer 101 generates a print queue. In step S5108, the user generates the print queue using a function provided by the OS of the host computer 101. Here, the host computer 101 associates the extension application 204 installed in step S5105 with the print queue. In step S5110, the host computer 101 displays the generated print queue to the user via the display unit 119.

In step S5111, the user instructs the host computer 101 to activate the extension application 204. An example of the activation instruction for the extension application 204 is an instruction issued from the print setting screen provided by the drawing application 201 or the OS to display the print setting screen provided by the extension application 204.

In step S5112, the host computer 101 activates the extension application 204. In step S5113, the host computer 101 displays the UI screen of the extension application 204 on the display unit 119. Details of the processing performed by the extension application 204 after the extension application 204 is activated by the user in step S5111 until the extension application 204 displays the UI screen on the display unit 119 in step S5113 will be described below.

FIG. 5C illustrates an example of the sequence in a case where the administrator does not directly distribute the custom setting information list 406 to the users in the company or organization but places the custom setting information list 406 on a separately prepared external server. In such a case, the information about the server to be accessed for each target company or organization is desirably stored in the extension application 204 in advance. The extension application 204 is therefore modified into one dedicated for the intended company or organization and provided for the company or organization's administrator. The configuration that the extension application 204 is dedicatedly modified for the company or organization is similar to that in FIG. 5A. In the case of FIG. 5C, the extension application 204 itself does not include the custom setting information, and the custom setting information list 406 is placed on the server. If the custom setting information is to be changed, only the information on the server can therefore be modified. One difference from FIG. 5A is therefore that the extension application 204 itself does not need to be modified. Moreover, unlike FIG. 5B, the custom setting information list 406, when modified, does not need to be distributed to the users. Thus, it can be expected that he occurrence of unintended issues arising from distribution omissions or distribution errors will be prevented.

In FIG. 5C, in step S5201, the administrator initially instructs the administrator PC to place the created custom setting information list 406 on the predetermined server.

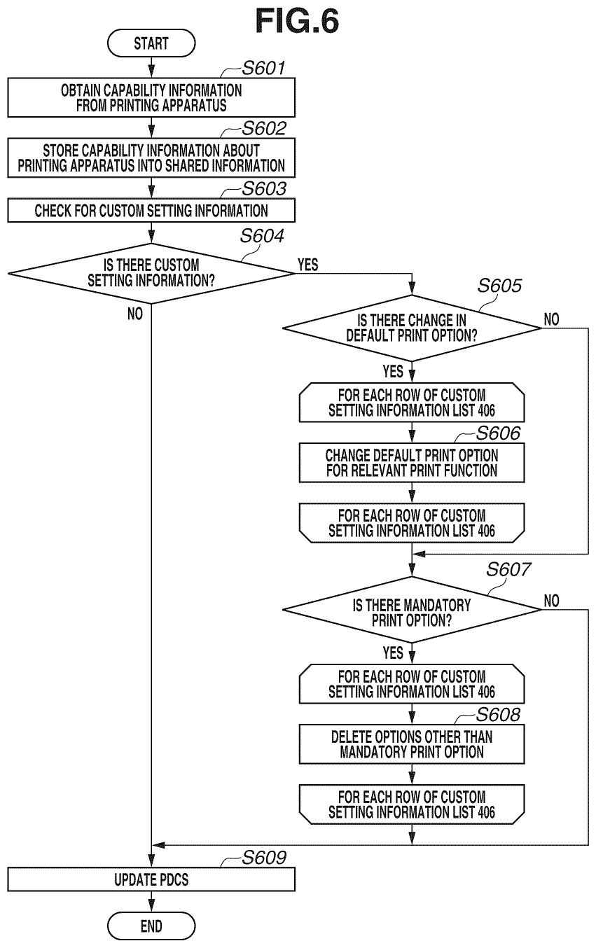

In step S5202, the administrator PC places the custom setting information list 406 on a predetermined server. The processing proceeds to step S5203. The custom setting information list 406 placed on the predetermined server by the administrator PC is used by the extension application 204 in FIG. 6 to be described below.

In step S5203, the administrator notifies the users in the company or organization that the extension application 204 including the information for accessing the server is to be distributed. Specifically, as in step S5001, the administrator can inform the users of the distribution of the extension application 204 through posting on the company or organization's internal website, verbal communication, e-mail, or other communication tools. In step S5204, the administrator then instructs the administrator PC to distribute the extension application 204. In step S5205, in response to receiving the administrator's instruction to distribute the extension application 204, the administrator PC distributes the extension application 204 to the users' host computers 101. The distribution method is similar to that of the extension application 204 in FIG. 5A

In step S5206, a user in the company or organization instructs their own host computer 101 to install the extension application 204. In step S5207, the host computer 101 installs the extension application 204. Here, the host computer 101 simultaneously installs the extended INF file that is the setup information about the extension application 204. The extended INF file is distributed to each user along with the extension application 204 by the administrator. After the completion of the installation, in step S5208, the host computer 101 displays the completion of the installation on the display unit 119 for user notification. The user installs the distributed extension application 204 on their own host computer 101. The processing proceeds to step S5209. In step S5209, the user in the company or organization instructs the host computer 101 to generate a print queue. In step S5210, in response to receiving the user instruction, the host computer 101 generates a print queue. Here, the host computer 101 associates the extension application 204 installed in step S5207 with the print queue. In step S5211, the host computer 101 displays the generated print queue to the user via the display unit 119. In step S5212, the user in the company or organization instructs their own host computer 101 to activate the installed extension application 204. In step S5213, the host computer 101 activates the extension application 204. In step S5214, the host computer 101 displays the UI screen of the extension application 204 on the display unit 119.

Details of the processing performed by the extension application 204 after the extension application 204 is activated by the user in step S5212 until the extension application 204 displays the UI screen on the display unit 119 in step S5214 will be described below.

Specific examples of the print function list 401 and the custom setting information list 406 and the sequences for situations where the company or organization's administrator creates the custom setting information list 406 and distributes the custom setting information list 406 to the users in the company or organization have been described above.

### PDC Edit Processing by Extension Application

Processing that the extension application 204 having been distributed to the users in the company or organization based on the sequences of FIG. 5A to 5C performs after activation will be described with reference to FIG. 6. A program for performing the flowchart illustrated in FIG. 6 is stored in the external storage device 114, and the processing is implemented by the CPU 111 executing the program.

In step S601, the user activates the extension application 204, and the print function extension unit 207 of the extension application 204 obtains the capability information from the printing apparatus 102. The capability information is obtained as a response from the printing apparatus 102 by the print function extension unit 207 issuing an IPP Get-Printer Attributes operation to the printing apparatus 102. After the extension application 204 obtains the capability information about the printing apparatus 102, the processing proceeds to step S602.

In step S602, the print function extension unit 207 stores the capability information about the printing apparatus 102 obtained by the processing of step S601 into the shared information 210. The stored capability information about the printing apparatus 102 is used by the print function extension unit 207 to edit PDCs 203. However, other units of the extension application 204 may also use the capability information for other use purposes. The print function extension unit 207 may be configured to, if the capability information about the printing apparatus 102 is already included in the shared information 210, skip the processing of step S601 upon subsequent activation of the extension application 204. After the print function extension unit 207 stores the capability information about the printing apparatus 102 into the shared information 210, the processing proceeds to step S603.

In step S603, the extension application 204 checks the presence of custom setting information. In the present exemplary embodiment, the administrator distributes the custom setting information list 406 to the users in the company or organization by using various methods described in conjunction with the foregoing FIGS. 5A to 5C. The processing where the extension application 204 checks the presence of the custom setting information in step S603 will now be described with reference to the respective sequences of FIGS. 5A to 5C.

In FIG. 5A, the extension application 204 is dedicatedly modified for the specific company or organization, and the custom setting information is included in the extension application 204 in advance. The extension application 204 thus constantly operates on the assumption that there is custom setting information. In the subsequent step S604, the extension application 204 determines whether there is custom setting information. Since the processing result is yes (YES in step S604), the processing proceeds to step S605.

In FIG. 5B where the administrator distributes the custom setting information list 406, the custom setting information list 406 is located in the predetermined information storage area allocated for the extension application 204 by the OS. The print function extension unit 207 of the extension application 204 thus accesses the predetermined information storage area using an API provided by the OS, and checks for the custom setting information list 406. In the subsequent step S604, the print function extension unit 207 determines whether there is custom setting information. If the print function extension unit 207 determines that there is custom setting information (YES in step S604), the processing proceeds to step S605.

In FIG. 5C, the administrator places the custom setting information list 406 on the server. The print function extension unit 207 of the extension application 204 thus accesses the server using the server access information stored therein, and checks the presence of the custom setting information list 406. In the subsequent step S604, if the print function extension unit 207 determines that there is custom setting information (YES in step S604), the processing proceeds to step S605.

If the print function extension unit 207 determines, according to the methods for checking the presence of custom setting information corresponding to the respective sequences of FIGS. 5A, 5B, and 5C, that there is no custom setting information (NO in step S604), the processing proceeds to step S609.

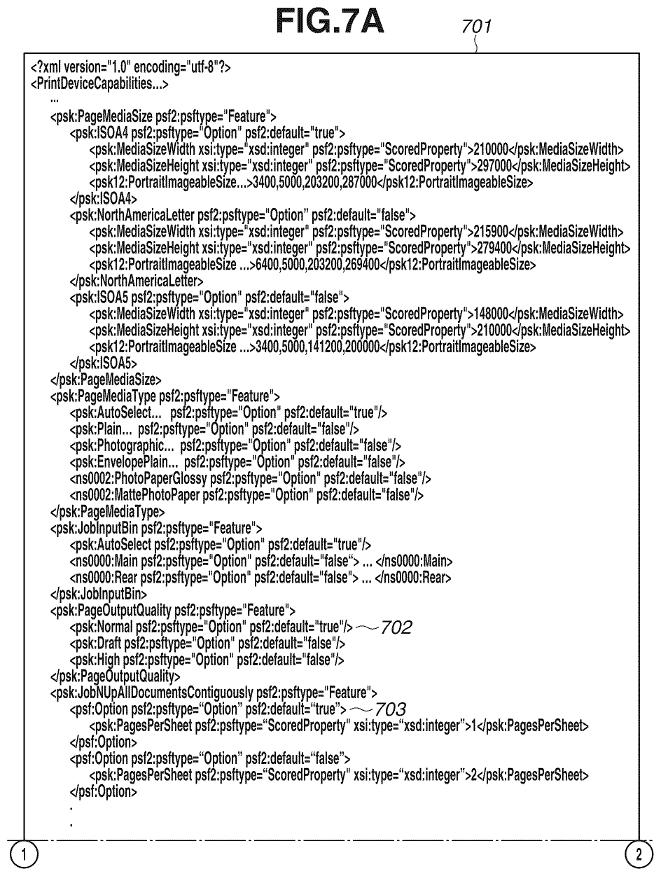

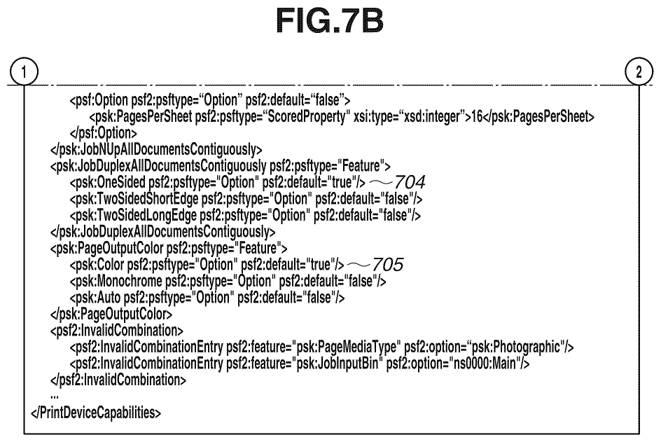

In step S609, the print function extension unit 207 updates PDCs 203 based on the capability information stored as the shared information 210. The PDC editing in the case where there is no custom setting information will now be described with reference to FIGS. 7A and 7B. FIGS. 7A and 7B illustrate an example of PDCs (PDCs 701) edited by the extension application 204 using only the capability information about the printing apparatus 102. Print function information 702 in PDCs 701 indicates a combination of print options and a default print option related to PageOutputQuality, specifically, “print function: print quality”. PageOutputQuality describes three types of print options, namely normal, draft, and high, where default =true is set to normal. This means that when the print function extension unit 207 edits PDCs 701 based on the capability information about the printing apparatus 102, the default print option for the print quality is set to normal. Print function information 703 in PDCs 701 indicates a combination of print options and a default print option for JobNUPAllDocumentsContiguously, specifically, the N-up function. JobNUPAllDocumentsContiguously describes PagesPerSheet of 1, 2, 4, 9, and 16. Of these, PagesPerSheet of 1 is set with default=true. This means that when the print function extension unit 207 edits PDCs 701 based on the capability information about the printing apparatus 102, the default operation for the N-up function is set to PagesPerSheet of 1.

Similarly, print function information 704 indicates the presence of options OneSided, TwoSidedShortEdge, and TwoSidedLongEdge for JobDuplexAllDocumentsContiguously (two-sided printing function). Among the print options for the two-sided printing function, OneSided, specifically, one-sided printing is the default print option. Print function information 705 indicates the presence of options color, monochrome, and auto for PageOutputColor, specifically, “print function: color mode”. Of these, color, specifically, color printing is the default print option.

An example where the extension application 204 edits PDCs 203 using only the capability information about the printing apparatus 102 has been described above. In the present exemplary embodiment, the print quality, N-up function, two-sided printing, and color mode have been named as examples of the print functions, and the print options and default print options for these print functions have been described. However, the combinations of print functions to be customized, print options, and default print options are not limited to those described in the present exemplary embodiment.

Return to the description of FIG. 6. In step S604, if the print function extension unit 207 determines that there is custom setting information (YES in step S604), the processing proceeds to step S605. In step S605, the print function extension unit 207 refers to the details of the custom setting information list 406 obtained in step S603, and checks the custom setting information types for a change in a default print option. In step S605, if the print function extension unit 207 determines that there is a change in a default print option in the custom setting information (YES in step S605), the processing proceeds to step S606. If the print function extension unit 207 determines that there is no change in any default print option (NO in step S605), the processing proceeds to step S607. The processing of step S607 will be described below.

Next, step S606 will be specifically described with reference to the print function list 401 of FIG. 4A and the custom setting information list 406 of FIG. 4B. In the custom setting information list 406, the rows 407 and 408 include information for specifying default print options. Specifically, the information specifies changes in the default print options for the N-up function and the two-sided printing. The row 402 of the print function list 401 indicates that the default print option for “print function: N-up” based on the capability information obtained from the printing apparatus 102 is 1 in 1. In contrast, the row 407 of the custom setting information list 406 specifies 2 in 1 as the default print option. The print function extension unit 207 updates the information in the shared information 210 with 2 in 1 specified in the row 407 as the default print option for “print function: N-up”. Similarly, the row 403 of the print function list 401 indicates that the default print option for “print function: two-sided printing” based on the capability information obtained from the printing apparatus 102 is one-sided. In contrast, the row 408 of the custom setting information list 406 specifies two-sided as the default print option. The print function extension unit 207 updates the information in the shared information 210 with two-sided specified in the row 408 as the default print option for “print function: two-sided printing”. In such a manner, the print function extension unit 207 performs the foregoing processing on the rows indicating changes in default print options. The print function extension unit 207 then updates the information in the shared information 210 regarding the combinations of print functions subject to change as to default print options and the default print options described in the custom setting information list 406. The processing proceeds to step S607.

In step S607, the print function extension unit 207 determines whether there is a mandatory print option as a custom setting image type in the custom setting information list 406. If, in step S607, the print function extension unit 207 determines that there is a mandatory print option in the custom setting information list 406 (YES in step S607), the processing proceeds to step S608. If the print function extension unit 207 determines that there is no mandatory print option in the custom setting information list 406 (NO in step S607), the processing proceeds to step S609. The processing of step S609 will be described below.

Step S608 will be specifically described, again, with reference to the print function list 401 of FIG. 4A and the custom setting information list 406 of FIG. 4B. The rows 409 and 410 of the custom setting information list 406 include information specifying mandatory print options. Specifically, the rows 409 and 410 indicate that mandatory print options are to be applied to “print function: print quality” and “print function: color mode”. The row 404 of the print function list 401 indicates that there are three types of print options for “print function: print quality” based on the capability information obtained from the printing apparatus 102, namely, high, normal, and draft. In contrast, the row 409 of the custom setting information list 406 indicates that the print option draft is mandated for “print function: print quality”. The print function extension unit 207 updates the information in the shared information 210 so that the print option specified in the row 407, draft, is set to the print option for “print function: print quality”, and high and normal are deleted from the print options. Similarly, the row 405 of the print function list 401 indicates that color is specified as the default print option for “print function: color mode” based on the capability information obtained from the printing apparatus 102. In contrast, the row 410 of the custom setting information list 406 indicates that monochrome is mandated as the print option. The print function extension unit 207 updates the information in the shared information 210 so that the print option specified in the row 408, monochrome, is set to the print option for “print function: color mode”, and color and auto are deleted from the print options. In such a manner, the print function extension unit 207 performs the foregoing processing on the rows indicating mandatory print options in the custom setting information list 406, and updates the information in the shared information 210 regarding the combinations of the print functions and print options. The processing proceeds to step S609.

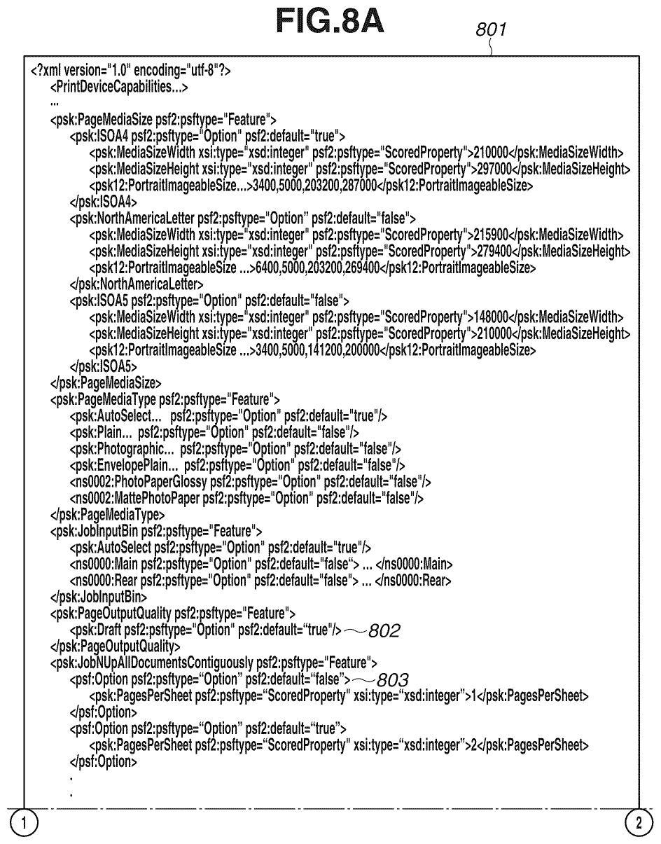

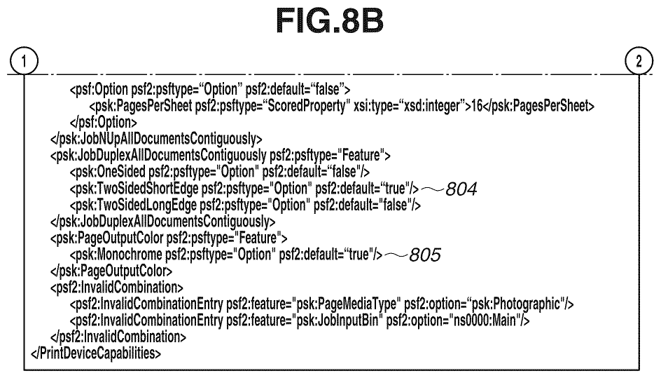

In step S609, the print function extension unit 207 updates PDCs 203 based on the information stored in the shared information 210. The editing of PDCs 203 using the information in the information 210 updated with the information described in the custom setting information list 406 will now be described with reference to FIGS. 8A and 8B.

FIGS. 8A and 8B illustrate an example of PDCs (PDCs 801) edited by the print function extension unit 207 based on the capability information about the printing apparatus 102 as well as the information in which the changes in the default print options and the mandatory print options described in the custom setting information list 406 are reflected. Print function information 802 in PDCs 801 represents PageOutputQuality, or “print function: print quality”. The print options other than draft are deleted from the shared information 210 due to the mandatory print option that is custom setting information. The print function extension unit 207 describes only draft as a print option for PageOutputQuality in PDCs 801 and sets default =true based on the information in the shared information 210. In other words, the print function extension unit 207 updates PDCs 203 based on the information in the shared information 210 that the only print option for “print function: print quality” is draft, and sets draft to the default print option.

Print function information 803 in PDCs 801 indicates a combination of print options and a default print option related to JobNUPAllDocumentsContiguously, or “print function: N-up”. For JobNUPAllDocumentsContiguously, the print function extension unit 207 sets PagesPerSheet of 2 with default =true, due to the change in the default print option in the custom setting information. This means that 2 in 1 is set to the default print option for “print function: N-up”. Similarly, print function information 804 indicates a combination of print options and a default print option related to JobDuplexAllDocumentsContiguously, or “print function: two-sided printing”. For JobDuplexAllDocumentsContiguously, the print function extension unit 207 sets TwoSidedShortEdge with default=true due to the change in the default print option in the custom setting information. This means that two-sided printing (short edge) is set to the default print option for two-sided printing. Print function information 805 represents PageOutputColor, or “print function: color mode”. The options other than monochrome are deleted due to the mandatory print option in the custom setting information. Based on the information in the shared information 210, the print function extension unit 207 includes only monochrome as the print option for PageOutputColor in PDCs 801, and sets default=true. In other words, the print function extension unit 207 updates PDCs 203 based on the information in the shared information 210 that the only print option for “print function: color mode” is monochrome, and sets monochrome to the default print option.

An example where the extension application 204 edits PDCs 203 using the capability information about the printing apparatus 102 as well as the information in the shared information 210 that is updated using the information described in the custom setting information list 406 has been described above.

### UI Display of Print Functions and Print Options by Print Setting Screen Extension Unit

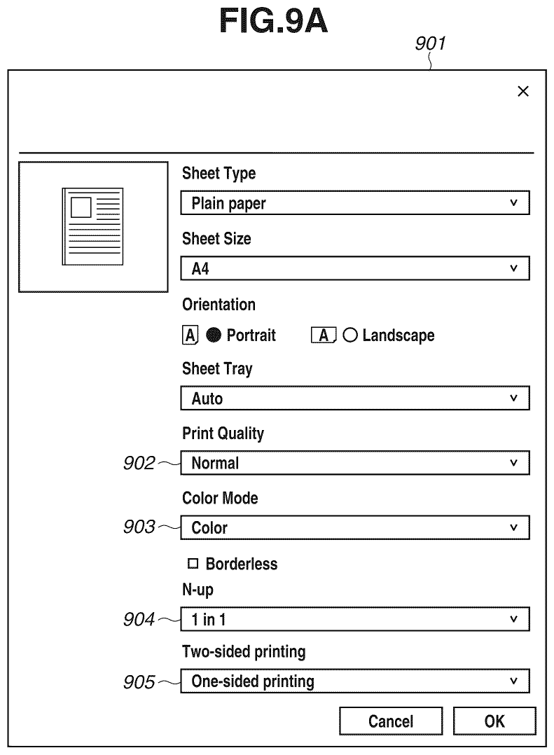

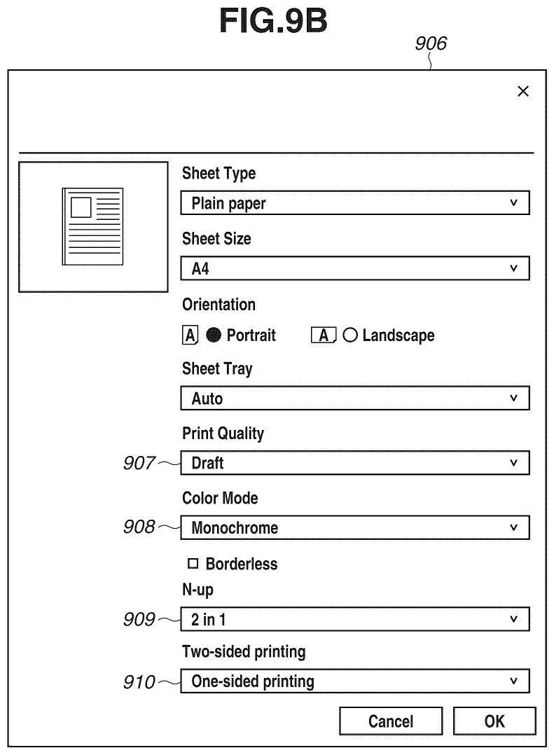

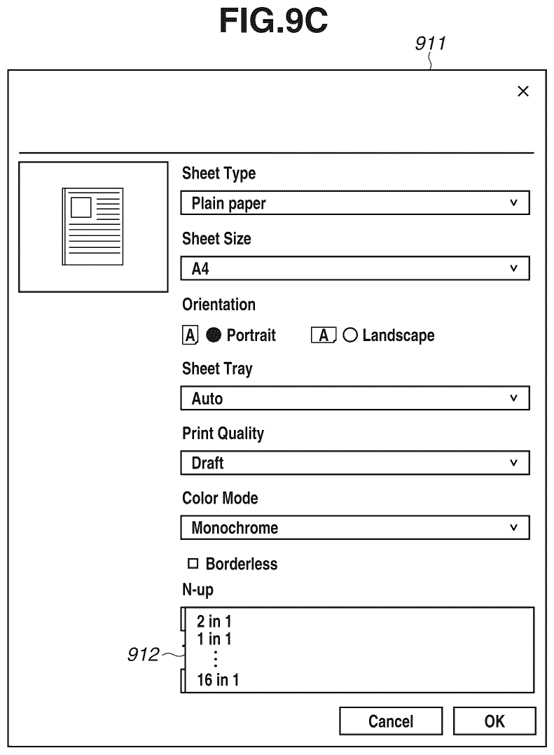

Next, the print setting screen that the print setting screen extension unit 205 displays based on PDCs 203 edited by the print function extension unit 207 will be described with reference to FIGS. 9A to 9C. PCs are generated based on PDCs 203 edited by the print function extension unit 207, and the print setting screen extension unit 205 displays the print setting screen based on the generated PCs.

Initially, the print setting screen based on PDCs 203 edited by the print function extension unit 207 using only the capability information about the printing apparatus 102 will be described with reference to FIG. 9A.

A control 902 on a print setting screen 901 of FIG. 9A is used for selecting “print function: print quality”. The print setting screen extension unit 205 displays normal as the default print option on the control 902 based on the print options and the default print option described in the print function information 702 in PDCs 701. Similarly, a control 903 is used for selecting “print function: color mode”. The print setting screen extension unit 205 displays color as the default print option. A control 904 is used for selecting “print function: N-up”, and displays 1 in 1 as the default print option. A control 905 is used for selecting “print function: two-sided printing”, and displays one-sided printing as the default print option for two-sided printing.

Next, FIG. 9B will be described. A print setting screen 906 of FIG. 9B is an example of the print setting screen based on PDCs 203 that has been edited by the print function extension unit 207 using the information described in the custom setting information list 406 in addition to the capability information about the printing apparatus 102. As with the print setting screen 901, a control 907 on the print setting screen 906 of FIG. 9B is used for selecting “print function: print quality”. The print setting screen extension unit 205 displays draft as the print option based on the default print option described in the print function information 802 in PDCs 801. The print function information 802 in PDCs 801 mandates the print option based on the specification in the custom setting information list 406. Setting draft to the default print option is mandatory, and the other options are unable to be selected using the control 907. A control 908 is used for selecting “print function: color mode”, and displays monochrome as the print option based on the print function information 805 in PDCs 801. The print function information 805 in PDCs 801 also mandates the print option based on the specification in the custom setting information list 406. The default print option monochrome is mandatory, and the other options are unable to be selected using the control 908.

A control 909 is used for selecting “print function: N-up”, and displays 2 in 1 as the default print option based on the print function information 803 in PDCs 801. Since the change in the default print option is reflected on the print function information 803 in PDCs 801 by the specification in the custom setting information list 406, the print options other than the default print option are also selectable. A case where the control 908 is expanded will be described with reference to FIG. 9C.

FIG. 9C is a diagram illustrating a print setting screen 911, where the control 909 on the print setting screen 906 of FIG. 9B is expanded into a control 912. The control 912 into which the control 909 is expanded also displays the print options other than the default print option 2 in 1, such as 1 in 1 and 16 in 1, which are selectable and settable.

Return to the description of FIG. 9B. A control 910 on the print setting screen 906 is used for selecting “print function: two-sided printing, and displays two-sided (short edge) based on the print function information 804 in PDCs 801. Since the change in the default print option is reflected on the print function information 804 in PDCs 801 by the specification in the custom setting information list 406, the print options other than the default print option are also selectable.

A example of the print setting screen displayed by the print setting screen extension unit 205 based on PDCs 801 edited by the print function extension unit 207 has been described above. In the present exemplary embodiment, how the mandatory print options and the changes in the default print options are reflected has been described by using the print setting screen displayed by the extension application 204 as an example. However, the mandatory print options and the changes in the default print options are also reflected on PCs generated from the edited PDCs 203. The print setting UI provided by the drawing application 201 and the print setting screen displayed by the OS can thus be similarly controlled.

The method described in the present exemplary embodiment enables the company or organization's administrator to change desired print options of the printing apparatus 102 into default print options or mandate the users to use given print options. Moreover, PCs are generated based on the edited PDCs 203. The details of the print options can thus be controlled with PCs even in situations where printing is executed from a print dialog displayed by the print data generation software 202 or other drawing applications.

### Registering Custom Setting Information in Printing Apparatus

Next, a second exemplary embodiment will be described. In the first exemplary embodiment, the extension application 204 itself operates with the custom setting information stored therein. In the foregoing descriptions, the extension application 204, with the custom setting information list 406 placed in a predetermined information storage area or on a server, determines the presence of the custom setting information list 406 and operates.

However, the custom setting information may be registered in the printing apparatus 102 in advance, and the extension application 204 may obtain the custom setting information from the printing apparatus 102.

Such a configuration can eliminate the need to modify the extension application 204 itself for a specific company or organization, unlike the first exemplary embodiment. Since the custom setting information list 406 does not need to be distributed to the users, either, the effect of reducing the burden on the administrator and preventing human errors associated with the process of distributing and applying the extension application 204 and the setting file is also expected.

In the present exemplary embodiment, the company or organization's administrator initially registers custom setting information in the printing apparatus 102. The custom setting information may be registered from a UI panel of the printing apparatus 102, or using a management application provided on an information processing apparatus or a web-based management tool. With the custom setting information in the printing apparatus 102 registered, the company or organization's administrator notifies the users in the company or organization in order to install the extension application 204. An example of the information registered as the custom setting information is that described in the table illustrated in FIG. 4B.

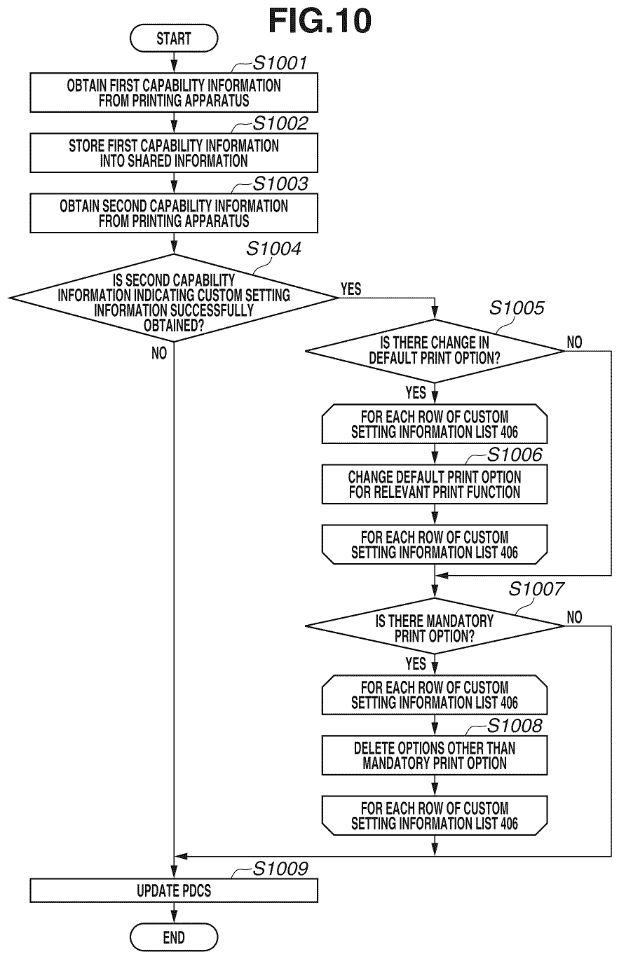

Next, a user belonging to the company or organization installs the extension application 204 on their own host computer 101. As described above in the first exemplary embodiment, the extension application 204 may be automatically downloaded from the application store and installed on the host computer 101 at timing when the host computer 101 is connected to the printing apparatus 102. The user then activates the extension application 204, and the processing of FIG. 10 is started.

The processing performed by the extension application 204 in the present exemplary embodiment will be described with reference to FIG. 10. The flowchart illustrated in FIG. 10 is implemented by the CPU 111 executing a program provided by the extension application 204.

In step S1001, the print function extension unit 207 of the extension application 204 obtains first capability information from the printing apparatus 102. In the present exemplary embodiment, the first capability information refers to the capability information about the printing apparatus 102 that is obtainable from the printing apparatus 102 as a response to an IPP Get-Printer-Attributes operation.

In step S1002, the print function extension unit 207 stores the obtained first capability information into the shared information 210. The capability information itself obtained in step S1001, the method for obtaining the capability information, and the details of the operation performed in step S1002 are similar to those of the first exemplary embodiment. Descriptions thereof will thus be omitted in the present exemplary embodiment.

In step S1003, the print function extension unit 207 obtains second capability information indicating custom settings from the printing apparatus 102. As in the first capability information, the second capability information is obtained as a response from the printing apparatus 102 by issuing an IPP Get-Printer-Attributes operation to the printing apparatus 102. In the present exemplary embodiment, the information to be obtained as the second capability information is originally defined attribute information that is defined aside from the first capability information. In the present exemplary embodiment, the second capability information is assumed to be information that the print function extension unit 207 can obtain using an IPP protocol. However, the second capability information may be obtained using proprietary communication other than IPP communication. The printing apparatus 102 may generate capability information with the custom settings reflected thereon, and the host computer 101 may obtain the updated capability information. This can reflect changes due to the custom settings to apply changes in print options and mandatory print options even in a case where a host computer 101 equipped with an OS other than Windows (registered trademark) described in the present exemplary embodiment performs IPP printing. After the print function extension unit 207 obtains the second capability information from the printing apparatus 102, the processing proceeds to step S1004.

In step S1004, the print function extension unit 207 determines whether the second capability information indicating the custom setting information (custom settings) is successfully obtained from the printing apparatus 102. If the print function extension unit 207 determines that there is second capability information (YES in step S1004), the processing proceeds to step S1005. If, in step S1004, the print function extension unit 207 determines that the second capability information is not successfully obtained from the printing apparatus 102 (NO in step S1004), the processing proceeds to step S1009. The operation of step S1009 will be described below.

Next, step S1005 will be described. In step S1005, the print function extension unit 207 refers to the second capability information indicating the custom setting information obtained in step S1003, and checks whether there is a change in a default print option as a custom setting information type. If, in step S1005, the print function extension unit 207 determines that there is a change in a default function option as a custom setting information type (YES in step S1005), the processing proceeds to step S1006. If the print function extension unit 207 determines that there is no change in any default function option (NO in step S1005), the processing proceeds to step S1007. The operation of step S1007 will be described below.

In step S1006, as in the first exemplary embodiment, the print function extension unit 207 changes the default print option of the relevant print function based on the details of the custom setting information, and stores the result into the shared information 210. The processing proceeds to step S1007.

In step S1007, the print function extension unit 207 refers to the second capability information indicating the custom setting information obtained in step S1003, and checks whether there is a mandatory print option as a custom setting information type. In step S1007, if the print function extension unit 207 determines that there is a mandatory print option as a custom setting information type (YES in step S1007), the processing proceeds to step S1008. If the print function extension unit 207 determines that there is no mandatory print option (NO in step S1007), the processing proceeds to step S1009.

In step S1008, the print function extension unit 207 deletes the print options other than that described in the custom setting information from the print options for the relevant print function based on the details of the custom setting information. The print function extension unit 207 then updates the shared information 210. The processing proceeds to step S1009.

In step S1009, the print function extension unit 207 updates PDCs 203 based on the capability information stored as the shared information 210. The updated PDCs 203 are similar to those in the first exemplary embodiment, illustrated in FIG. 8.

As described above, the custom setting information is registered in the printing apparatus 102 in advance, and PDCs 203 are updated based on the two types of capability information obtained from the printing apparatus 102. This eliminates the need to modify the extension application 204 into one dedicated to the company or organization. This can provide functions that meet the needs of the company or organization while eliminating the possibility of burdening the administrator or causing operational mistakes.

Next, a third exemplary embodiment will be described. In the first and second exemplary embodiments, the custom setting information is registered and managed in a predetermined information storage area of each host computer 101, on an external server, or in the printing apparatus 102. Alternatively, if the host computers 101 and the printing apparatus 102 are connected via a cloud service, the settings of the default print options may be registered in the cloud service.

In the first exemplary embodiment, the custom setting information itself or the information for connecting to the external server is built in the extension application 204. If such information is changed, the extension application 204 is therefore to be modified and reinstalled on the target host computers 101, which imposes a considerable burden on the administrator or users. If the custom setting information is placed in a predetermined information storage area, the extension application 204 does not need to be modified, but the custom setting information list 406 is to be modified and redistributed to the users by the administrator.

In the second exemplary embodiment, the originally defined attribute information is to be added to the capability information that is obtainable as an IPP Get-Printer-Attributes response, or a built-in mechanism for communicating the custom setting information between the printing apparatus 102 and the host computers 101 is to be provided.

Moreover, since a plurality of pieces of capability information is obtained from the printing apparatus 102 and PDCs 203 is edited based on the plurality of pieces of capability information, the amount of communication with the printing apparatus 102 increases.

The third exemplary embodiment is proposed in view of the foregoing issues. In the following description, system components not mentioned in particular are similar to those of the first exemplary embodiment, and a description thereof will be omitted. Processing procedures not mentioned in the following description are similar to those of the first exemplary embodiment, and a description thereof will be omitted.

### Reflecting Custom Setting Information in Printing System via Cloud Print Service

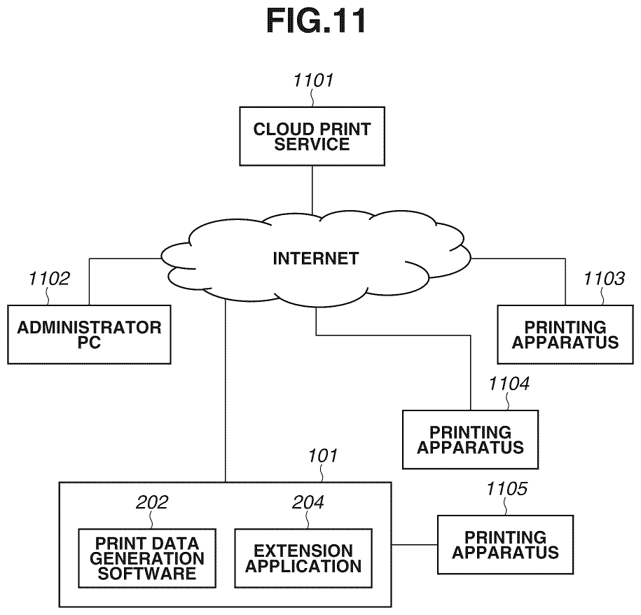

A configuration of a printing system according to the third exemplary embodiment will initially be described with reference to FIG. 11.

FIG. 11 is a diagram where an administrator PC 1102 of the company or organization and a host computer 101 including an extension application 204 are communicably connected to printing apparatuses 1103 and 1104 via a cloud print service 1101. An example of the cloud print service 1101 is Universal Print provided by Microsoft.

A user in the company or organization can log in to the cloud print service 1101 from the host computer 101, and transmit print data to a logical printing apparatus on the cloud print service 1101. The logical printing apparatus is a printing apparatus virtually generated on the cloud print service 1101. The host computer 101 can generate a print queue for the logical printing apparatus as in a locally connected printing apparatus 1105. The print data is transmitted from the host computer 101 to the cloud print service 1101 using UP Class Driver that is a kind of print data generation software 202 provided by the OS. The user prints via Universal Print by performing printing using UP Class Driver.

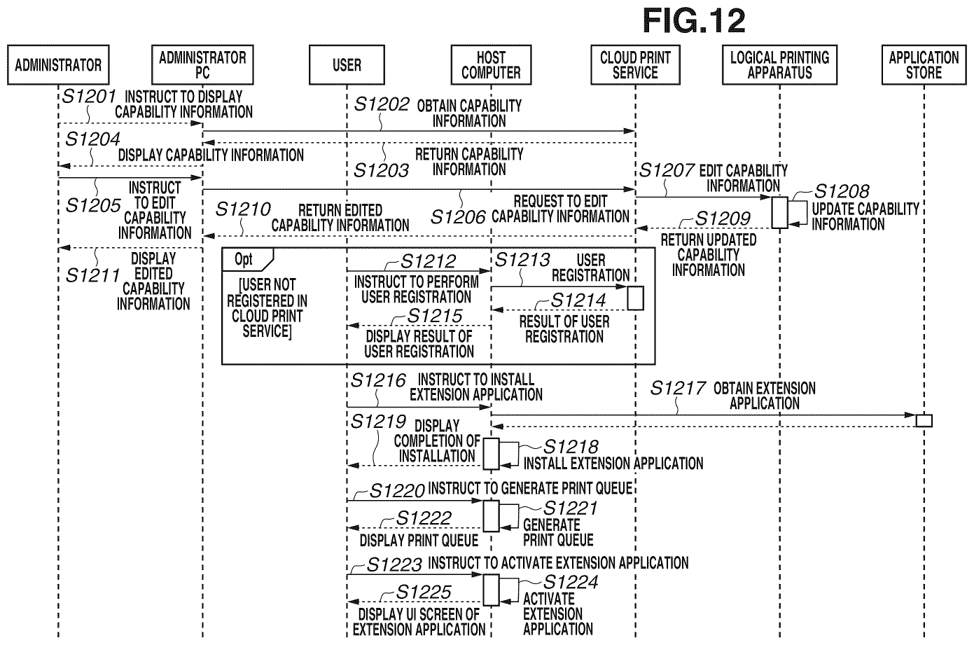

Next, a procedure for the company or organization's administrator to reflect custom setting information on the foregoing cloud print service 1101 will be described with reference to FIG. 12.

In step S1201 of FIG. 12, the company or organization's administrator instructs the administrator PC 1102 to display capability information about logical printing apparatuses on the cloud print service 1101. In step S1202, based on the administrator's instruction, the administrator PC 1102 accesses the cloud print service 1101 via the Internet and obtains the capability information about the logical printing apparatuses. In the present exemplary embodiment, the logical printing apparatuses corresponding to the printing apparatuses 1103 and 1104 are assumed to have been generated on the cloud print service 1101 by the administrator in advance, and a description thereof will be omitted. In step S1203, the cloud print service returns the capability information about the logical printing apparatuses to the administrator PC 1102. In step S1204, the administrator PC 1102 displays the capability information returned from the cloud print service on the display unit 119 for administrator notification.

In step S1205, the administrator instructs the administrator PC 1102 to edit the capability information about a logical printing apparatus.

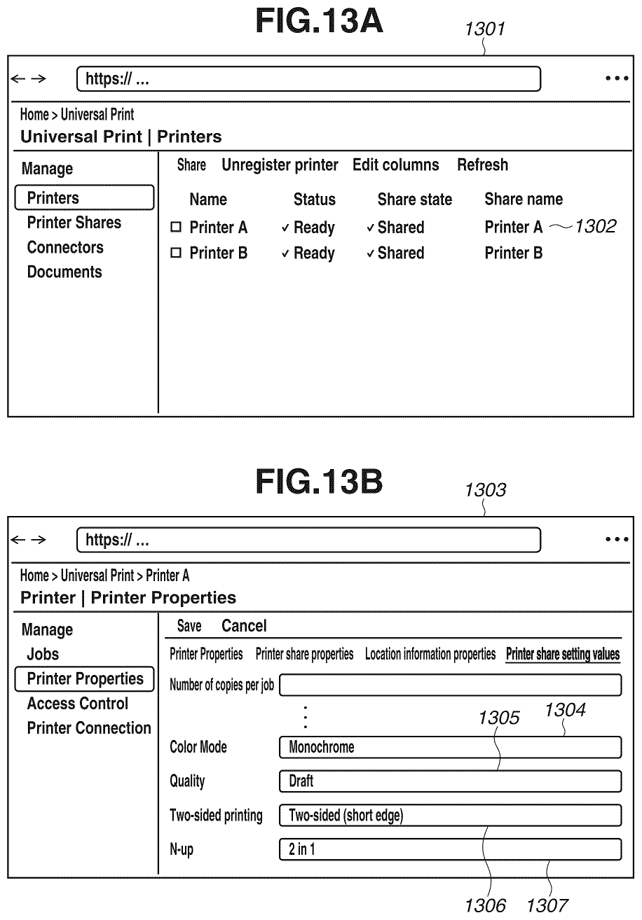

In the present exemplary embodiment, the administrator issues a capability information edit instruction for the logical printing apparatus corresponding to the printing apparatus 1103. The capability information edit instruction, which will be described below in conjunction with FIG. 13B, is an instruction to set default print options on the cloud print service 1101.

In step S1206, the administrator PC 1102 requests the cloud print service 1101 to edit the capability information as instructed by the administrator. In step S1207, the cloud print service 1101 edits the capability information about the logical printing apparatus. In step S1208, the logical printing apparatus updates its capability information. In step S1208, the cloud print service 1101 updates the default print options in the capability information about the logical printing apparatus managed as instructed in step S1206. The changes made by the administrator are thereby reflected on the default print options in the capability information about the logical printing apparatus to be notified from the cloud print service to the host computer 101 in generating a print queue on the host computer 101 afterward.

In step S1209, the logical printing apparatus returns the updated capability information to the cloud print service 1101. In step S1210, the cloud print service 1101 returns the edited capability information about the logical printing apparatus to the administrator PC 1102. In step S1211, the administrator PC 1102 displays the edited capability information to the administrator via the display unit 119.

To use the cloud print service 1101 involves user registration in the cloud print service 1101. If a user in the company or organization has not registered in the cloud print service 1101, the user then performs user registration on the cloud print service 1101. In step S1212, the user instructs the host computer 101 to perform user registration on the cloud print service 1101. In step S1213, the host computer 101 performs user registration on the cloud print service 1101 and registration for use on the cloud print service 1101.

In step S1214, the cloud print service 1101 returns a result of the user registration to the host computer 101. In step S1215, the host computer 101 displays the result of the user registration to the user via the display unit 119. Once the user performs the user registration on the cloud print service 1101, the user can transmit jobs to the logical printing apparatuses generated on the cloud print service 1101 and print using the printing apparatuses 1103 and 1104.

In steps S1216 to S1225, the extension application 204 obtained from the application store is installed on the user's host computer 101. After the installation, the user generates a print queue and activates the extension application 204. This processing is similar to the operations in steps S5103 to S5113 in FIG. 5B. A description thereof will thus be omitted. Details of the processing performed by the extension application 204 after the extension application 204 is activated by the user in step S1223 until the extension application 204 displays the UI screen on the display unit 119 in step S1225 will be described below.

Next, a method for the administrator to edit the capability information about the printing apparatus connected via the cloud print service 1101 using an interface provided by the cloud print service 1101 will be described with reference to FIGS. 13A and 13B.

FIG. 13A illustrates an apparatus management interface 1301 provided by the cloud print service 1101. The company or organization's administrator logs in to the cloud print service 1101 from the administrator PC 1102 via the Internet. The printing apparatuses 1103 and 1104 connected via the cloud print service 1101 can be managed on the screen of the apparatus management interface 1301 displayed by the administrator PC 1102. In the present exemplary embodiment, the printing apparatus 1103 will be treated as Printer A, and the printing apparatus 1104 as Printer B.

If the administrator selects Printer A from a control 1302 on the apparatus management interface 1301, the screen transitions to an apparatus management interface 1303 of FIG. 13B. The administrator can edit specific capability information about the printing apparatus 1103 that is Printer A on the apparatus management interface 1303. A control 1304 on the apparatus management interface 1303 is used for changing the default print option for “print function: color mode”. If monochrome is selected on the control 1304, the capability information about the printing apparatus 1103 is edited so that the default print option for “print function: color mode” is set to monochrome, and monochrome is returned as the default print option by an IPP communication response. If draft is selected on a control 1305, the capability information about the printing apparatus 1103 is edited so that draft is returned as the default print option for “print function: print quality”. If two-sided (short edge) is selected on a control 1306, the capability information about the printing apparatus 1103 is edited so that two-sided (short edge) is returned as the default print option for “print function: two-sided printing”. If 2 in 1 is selected on a control 1307, the capability information about the printing apparatus 1103 is edited so that 2 in 1 is returned as the default print option for “print function: N-up”.

In such a manner, using the apparatus management interface provided by the cloud print service 1101, the administrator can freely customize the capability information to be returned from the printing apparatuses 1103 and 1104 on the cloud print service 1101.

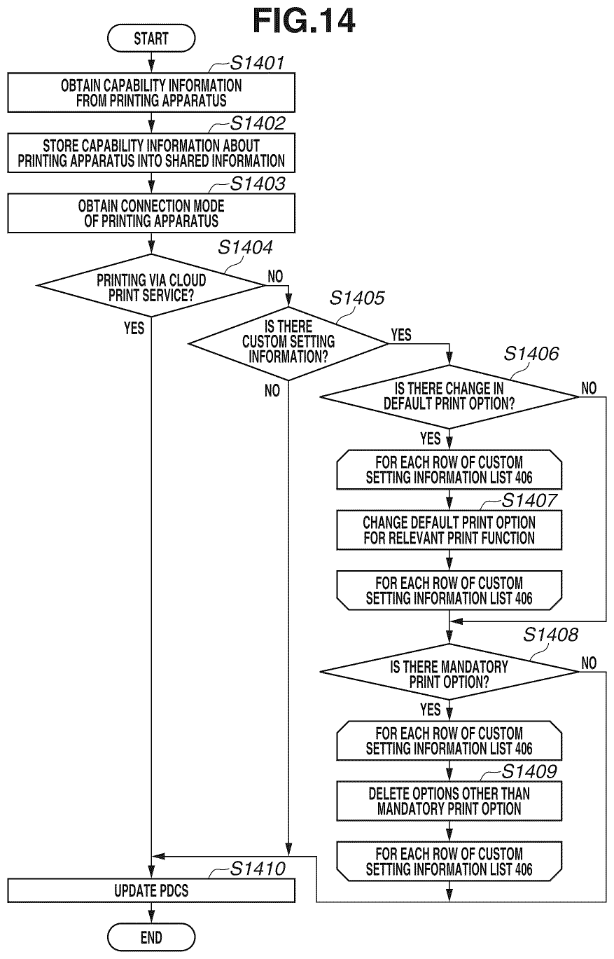

Next, processing performed when the extension application 204 installed on the host computer 101 of the user in the company or organization is activated will be described with reference to FIG. 14.

The processing of steps S1401 and S1402 is similar to that of steps S601 and S602 of FIG. 6 according to the first exemplary embodiment. A description thereof will thus be omitted. For local printing, the printing apparatus described in conjunction with steps S1401 to S1403 of FIG. 14 is an actual printing apparatus. For the cloud print service, the printing apparatus is a logical printing apparatus.

In step S1403, the print function extension unit 207 obtains the connection mode of the printing apparatus, whether local printing or printing via the cloud print service. The connection mode is determined based on attribute information indicating a consumable type, included in the capability information obtained by executing an IPP Get-Printer-Attributes operation. Alternatively, the connection mode may be determined by obtaining hardware identifier (HWID) information about the print queue associated with the printing apparatus via an API of the OS and referring to a specific character string included in the HWID information. The print function extension unit 207 may determine the connection mode by making an inquiry to the cloud print service 1101.

In step S1403, the print function extension unit 207 obtains the type of connection mode of the printing apparatus. The processing proceeds to step S1404.

In step S1404, the print function extension unit 207 switches processing based on the connection mode of the printing apparatus obtained in step S1403. Specifically, if, in step S1404, the print function extension unit 207 determines that the connection mode of the printing apparatus is one going through the cloud print service 1101 (YES in step S1401), the processing proceeds to step S1410. More specifically, if the connection mode one going through the cloud print service 1101, the company or organization's administrator can change the default print options for the print functions on the apparatus management interface 1303 provided by the cloud print service 1101. The changed default print options are therefore given priority. The print function extension unit 207 stores the capability information obtained from the printing apparatus into the shared information 210. The processing proceeds to step S1410.

If the connection mode of the printing apparatus is determined to be local printing (NO in step S1404), the processing proceeds to step S1405. The operations of steps S1405 to S1409 is similar to those of steps S604 to S608. A description thereof will thus be omitted.

The operation of step S1410 is also similar to that of step S609 in the first exemplary embodiment. If the connection mode is one going through the cloud print service 1101, the print function extension unit 207 edits PDCs 203 by using only the capability information obtained from the printing apparatus, stored in the shared information 210. Only if the connection mode is local printing, the print function extension unit 207 updates the capability information obtained from the printing apparatus with the custom setting information, and stores the updated capability information into the shared information 210. The print function extension unit 207 then edits PDCs 203 using the information stored in the shared information 210.

With such a configuration, for the printing apparatus via the cloud print service 1101, the default print options can be changed on the apparatus management interface 1303 provided by the cloud print services 1101. This eliminates the need to modify the extension application 204 for the company or organization. Moreover, the administrator can efficiently reflect the custom setting information on the host computers 101 in the company or organization with improved convenience.

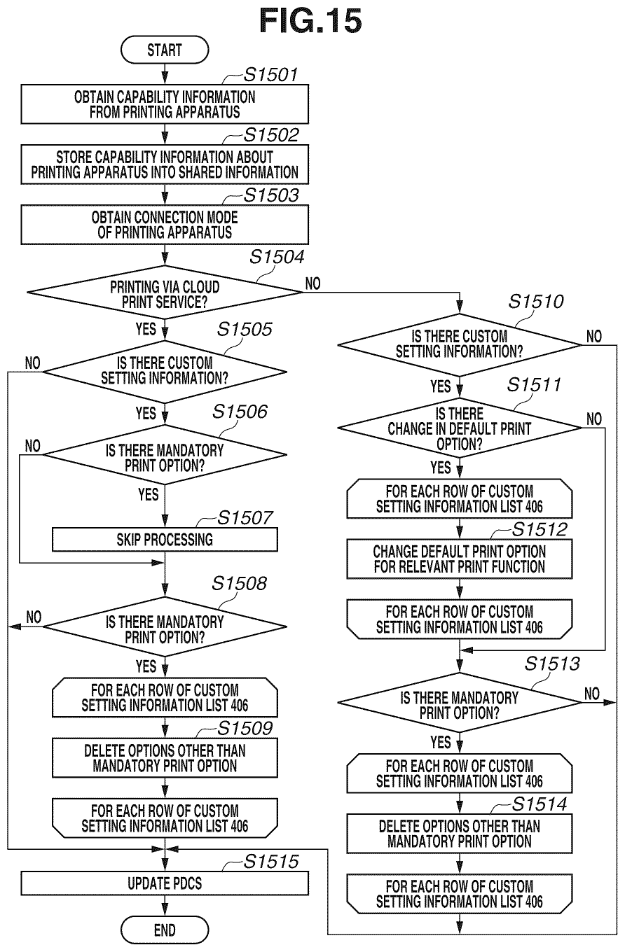

In the foregoing processing of FIG. 14, it is only the default print options that can be changed on the apparatus management interface 1303 provided by the cloud print service 1101. To mandate print options as custom setting information, the administrator may therefore place the custom setting information in a predetermined information storage area allocated for the extension application 204 or on a server as with local printing. The processing in the case where the administrator prepares and distributes the custom setting information list 406 for mandating print options will be described with reference to FIG. 15.

The operations of steps S1501 to S1504 are similar to those of steps S1401 to 1404 in the processing flowchart of FIG. 14. A description thereof will thus be omitted. If the determination of step S1504 indicates yes (YES in step S1504), the processing proceeds to step S1505.

In step S1505, unlike the processing flowchart of FIG. 14, the print function extension unit 207 determines whether there is custom setting information. The specific operation of step S1505 is similar to that of step S604 according to the first exemplary embodiment. If the determination of step S1505 indicates yes (YES in step S1505), the processing proceeds to step S1506.

In step S1506, the print function extension unit 207 checks whether a change in a default print option is included in the custom setting information. If no (NO in step S1506), the processing proceeds to step S1508. If yes (YES in step S1506), the processing proceeds to step S1507. Since the default print options can be changed on the apparatus management interface 1303 of the cloud print service 1101, the capability information edited by the cloud print service 1101 is given priority, and the processing itself is skipped. While steps S1506 and S1507 explicitly illustrate the skipping of the processing for changing the default values of the custom setting information, the processing may simply proceed from step S1505 to step S1508 without performing steps S1506 and S1507.

In step S1508, the print function extension unit 207 checks whether there is a mandatory print option in the custom setting information. If the determination of step S1508 is yes (YES in step S1508), the processing proceeds to step S1509. The specific operation of step S1509 is similar to that of step S608 according to the first exemplary embodiment. If the determination of step S1508 indicates no (NO in step S1508), the processing proceeds to step S1515.

Return to the description of step S1504. If the determination of step S1504 indicates no (NO in step S1504), the processing proceeds to step S1510. The operations of steps S1510 to S1514 are similar to those of steps S605 to S608 according to the first exemplary embodiment. After the print function extension unit 207 performs the processing up to step S1514, the processing proceeds to step S1515. Again, the operation of S1515 is similar to that of step S609 according to the first exemplary embodiment. Such processing is performed so that, in the case of the printing apparatus via the cloud print service 1101, the custom setting information about mandatory print options can also be reflected in addition to changes in the default print functions, made on the apparatus management interface 1303 of the cloud print service 1101.

### Mandate Use of Extension Application for Print Queue

If print options of the printing apparatus are mandated or default print options are to be changed with the foregoing method illustrated in FIG. 5A or 5B, there can be other extension applications in the application store than the extension application 204 dedicatedly modified for the company or organization.

In such a case, when the user generates a print queue, the OS may associate an extension application in the application store with the print queue by priority over the modified extension application 204. If so, the users in the company or organization are unable to use the modified extension application 204, and the administrator is unable to apply the mandatory print options or the changes in the default print options due to the extension application 204 to the print settings. In view of this, the modified extension application 204 is set to be associated with the print queue by priority over the extension application distributed from the application store.

A method for associating the modified extension application 204 with the print queue by priority will be described.

An example of the method for associating the modified extension application 204 with the print queue by priority is to edit the registry. The company or organization's administrator provides the users belonging to the company or organization with a method or file for changing the registry to mandate the use of the modified extension application 204. One provision method may be for the administrator to inform the users of the key editing method by e-mail. The administrator may post the editing method on a server shared in the company or organization, and the users may obtain the editing method from the server. Similarly, the editing method may be posted on a cloud storage server shared in the company or organization. Alternatively, the administrator may distribute the registry keys to the users' host computers 101 using a client management tool. An example of the modification file to be distributed is a file of.reg format.

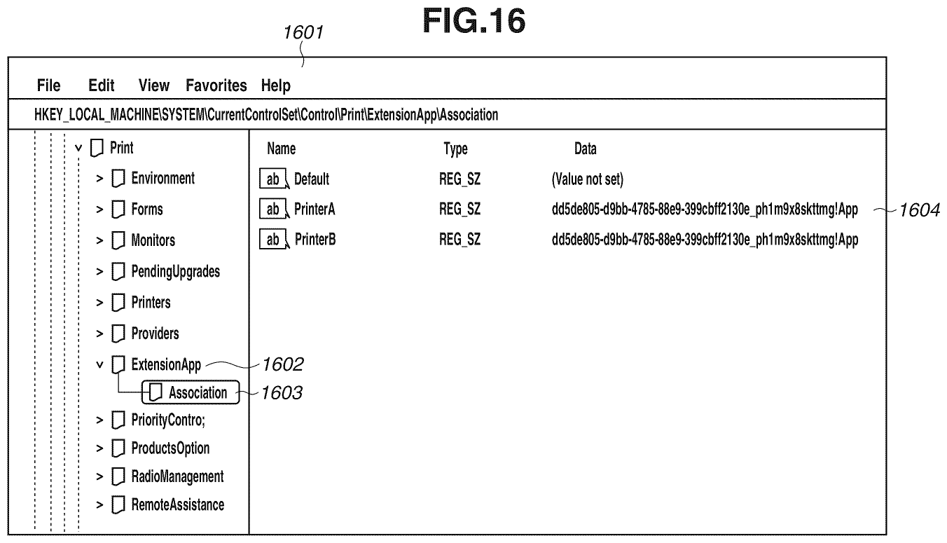

Next, details of the registry keys to be distributed to the users to associate the modified extension application 204 with the print queue by priority will be described with reference to FIG. 16.

FIG. 16 illustrates an example of a graphical user interface (GUI) screen registry edit screen 1601 provided to edit the OS's registry. A registry key 1602 to edit settings related to the extension application 204 can be created under HKEY_LOCAL_MACHINE\SYSTEM\CurrentControlSet\Control\Print\. A registry key 1603 to set association between the extension application 204 and the print queue is created directly under the registry key 1602. Values are then added under the created registry key 1603. The added values are Registry String Values (REG_SZ), specifically, character string values. After the creation of a character string value, the name of the relevant printing apparatus is specified as a value name, and an Application User Model ID (AUMID) 1604 for associating the application is specified as data. An AUMID 1604 is an ID for linking a specific application with a specific process, file, or window. For example, in the present exemplary embodiment, the printing apparatus is Printer A, and the AUMID 1604 of the extension application 204 is dd5de805-d9bb-4785-88e9-399cbff2130e_ph1m9x8skttmg!App.

A specific key is created in the registry and a value is set in such a manner, so that the specific printing apparatus can be associated with the extension application 204 dedicatedly modified for the company or organization, not with an extension application distributed from the application store.

In all the foregoing exemplary embodiments, the extension application 204 is desirably installed on the host computer 101 and activated and operated in association with a print queue when the print queue is generated. However, the user can print without the extension application 204 installed on the host computer 101, if there is print data generation software. The mandate of print options and changes in the default print options are therefore unable to be controlled if the user intentionally does not install the extension application 204, or uninstalls the installed extension application 204.

To avoid such an issue, the company or organization's administrator may configure the host computer 101 to restrict the execution of printing by the print data generation software if the extension application 204 is not present on the host computer 101.

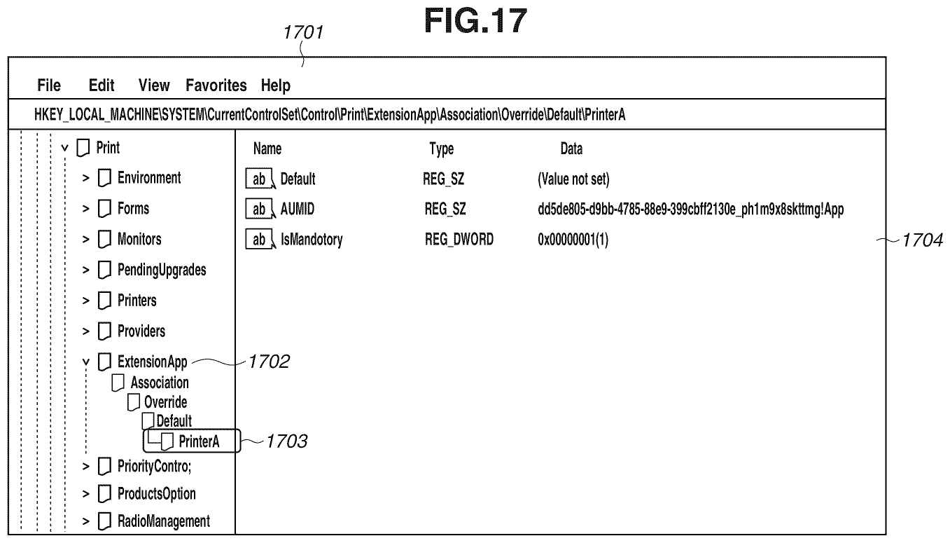

To restrict the execution of printing by the print data generation software in the absence of the extension application 204, the company or organization's administrator may distribute registry keys to the users' host computers 101. The registry keys to be distributed to the users by the administrator will be described with reference to FIG. 17.

FIG. 17 illustrates an example of a GUI screen registry edit screen 1701 provided to edit the OS registry. A registry key 1702 to edit settings related to the extension application 204 can be created under HKEY_LOCAL_MACHINE\SYSTEM\CurrentControlSet\Control\Print\. A registry key 1703, ExtensionApp\Association\Override\Default\PrinterA, can be created under the registry key 1702. This registry key 1703 can be used to set information related to the extension application 204 for Printer A. In the registry key 1703, a value 1704 to select whether to enable printing only when the extension application 204 is associated can be set. After the creation of the registry key 1703, values are added. The added value 1704 can be a Registry Double Word (REG_DWORD) value, specifically, a 32-bit value. Setting the REG_DWORD value to 1 can enable printing using Printer A only if the extension application 204 is associated.

Setting specific keys and values in the registry in this way can impose restriction that a specific printing apparatus is unable to print unless the extension application 204 is associated. This can prevent situations where printing unintended by the company or organization's administrator is executed from a host computer where the extension application 204 is not installed.

As described above, according to the foregoing exemplary embodiments, the company or organization's administrator can apply custom setting information to the host computers of the users who use the print data generation software 202 in the company or organization, using the extension application 204. As a result, for each usable print function, the default print option can be changed to a desired one, or a print option can be mandated. Changing the default print options and mandating certain print options can reduce printing cost, save resources, and prevent printing failures. This increases the use value of the standard OS printing and the extension application 204 to the users.

According to an exemplary embodiment of the present disclosure, in situations where a generic printer driver is used, the usable setting items, setting values, and values to be displayed by default can be customized.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-144453, filed Sep. 6, 2023, which is hereby incorporated by reference herein in its entirety.

What is claimed is:

1. A non-transitory computer-readable storage medium storing an application program causing an information processing apparatus to perform a control method, the application program supporting a function of printing software, the control method comprising:
obtaining capability information from a printer;
storing print function information including information corresponding to the obtained capability information; and
deleting at least one of a plurality of setting values indicated by the print function information based on restriction information about a print setting.

2. The non-transitory computer-readable storage medium according to claim 1, wherein the control method further comprises displaying a print setting screen based on the print function information.

3. The non-transitory computer-readable storage medium according to claim 2, wherein the restriction information includes information about an initial value to be displayed on the print setting screen.

4. The non-transitory computer-readable storage medium according to claim 3,
wherein the print function information includes information indicating an initial value of a setting item settable via the print setting screen, and
wherein the control method further comprises updating the initial value of the setting item included in the print function information.

5. The non-transitory computer-readable storage medium according to claim 2, wherein the restriction information includes information indicating a setting value restricted from being set via the print setting screen.

6. A control method to be implemented by executing an application program supporting a function of printing software, the control method comprising:
obtaining capability information from a printer;
storing print function information including information corresponding to the obtained capability information; and
deleting at least one of a plurality of setting values indicated by the print function information based on restriction information about a print setting.

7. The control method according to claim 6, further comprising displaying a print setting screen based on the print function information.

8. The control method according to claim 7, wherein the restriction information includes information about an initial value to be displayed on the print setting screen.

9. The control method according to claim 8,
wherein the print function information includes information indicating an initial value of a setting item settable via the print setting screen, and
wherein the control method further comprises updating the initial value of the setting item included in the print function information.

10. The control method according to claim 7, wherein the restriction information includes information indicating a setting value restricted from being set via the print setting screen.

11. An information processing apparatus storing printing software and an application program supporting a function of the printing software, the information processing apparatus comprising at least one processor operating to:
obtain capability information from a printer;
store print function information including information corresponding to the obtained capability information; and
delete at least one of a plurality of setting values indicated by the print function information based on restriction information about a print setting.
